(19) United States
(12) Patent Application Publication
(10) Pub. No.: US 2026/0075452 A1
(43) Pub. Date: Mar. 12, 2026

(54) TECHNIQUES TO FACILITATE MEASUREMENT GAP REQUIREMENTS PER L1 MEASUREMENT SCENARIO IN L1/L2 BASED MOBILITY

(71) Applicant: QUALCOMM Incorporated, San Diego, CA (US)

(72) Inventors: Yan ZHOU, San Diego, CA (US); Fang YUAN, Beijing (CN); Yong LI, San Diego, CA (US); Changhwan PARK, San Diego, CA (US); Kazuki TAKEDA, Minato-ku, Tokyo (JP); Valentin Alexandru GHEORGHIU, Yokohama-shi, Tokyo (JP); Mostafa KHOSHNEVISAN, San Diego, CA (US); Jelena DAMNJANOVIC, Del Mar, CA (US)

(21) Appl. No.: 19/108,070

(22) PCT Filed: Oct. 13, 2022
(86) PCT No.: PCT/CN2022/125011

§ 371 Date: Feb. 28, 2025

(51) Int. Cl. H04W 24/10; H04L 27/26

(52) U.S. Cl. CPC H04W 24/10; H04L 27/26025

(57) ABSTRACT

Apparatus, methods, and computer-readable media facilitating wireless communication at a UE are disclosed herein. An example method includes receiving a (L1 measurement configuration for a set of SpCells for L1 or L2 inter-cell mobility, the L1 measurement configuration associated with a measurement gap for a measurement object that is located at least at one of: within a configured BW of an activated serving cell and outside an active BWP, outside the configured BW and outside the active BWP, or within the configured BW and the active BWP and with at least one of a center frequency or a subcarrier spacing that is different than a measured measurement object of the activated serving cell. The example method also includes performing an L1 measurement for a candidate measurement object based on the L1 measurement configuration. The example method also includes transmitting an L1 measurement report based on the L1 measurement.

### TECHNICAL FIELD

The present disclosure relates generally to communication systems, and more particularly, to wireless communication employing inter-cell mobility.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication. An apparatus may include a user equipment (UE). The example apparatus may receive a layer 1 (L1) measurement configuration for a set of special cells (SpCells) for L1 or layer 2 (L2) inter-cell mobility. The L1 measurement configuration may be associated with a measurement gap for a measurement object that is located at least at one of: within a configured bandwidth (BW) of an activated serving cell and outside an active bandwidth part (BWP), outside the configured BW and outside the active BWP, or within the configured BW and the active BWP and with at least one of a center frequency or a subcarrier spacing that is different than a measured measurement object of the activated serving cell. The example apparatus may also perform an L1 measurement for a candidate measurement object based on the L1 measurement configuration. Additionally, the example apparatus may transmit an L1 measurement report based on the L1 measurement.

In another aspect of the disclosure, a method, a computer-readable medium, and an apparatus are provided for wireless communication. An apparatus may include a network entity, such as a base station. The example apparatus may output an L1 measurement configuration for a set of SpCells for L1 or L2 inter-cell mobility at a UE. The L1 measurement configuration may be associated with a measurement gap for a measurement object that is located at least at one of: within a configured BW of an activated serving cell and outside an active BWP, outside the configured BW and outside the active BWP, or within the configured BW and the active BWP and with at least one of a center frequency or a subcarrier spacing that is different than a measured measurement object of the activated serving cell. The example apparatus may also obtain an L1 measurement report based in part on the L1 measurement configuration.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram that illustrates an example cell configuration including an L1/L2 mobility configured cell set in accordance with various aspects of the present disclosure.

FIG. 5A is a diagram that illustrates an example of dual connectivity and carrier aggregation (CA), in accordance with various aspects of the present disclosure.

FIG. 5B illustrates an example diagram in which a set of cells is configured for a UE for L1/L2 mobility, and one or more of the cells may be activated, and a remaining subset of the cells may be deactivated, in accordance with various aspects of the present disclosure.

FIG. 6 depicts a diagram illustrating a single SpCell change without carrier aggregation, in accordance with various aspects of the present disclosure.

FIG. 7 depicts a timing diagram that illustrates communications between an active SpCell and a UE, in accordance with various aspects of the present disclosure.

FIG. 8 is a diagram that illustrates three examples of inter-frequency scenarios that may be supported for L1/L2 inter-cell mobility, in accordance with various aspects of the present disclosure.

FIG. 9 illustrates an example communication flow between a network entity and a UE, in accordance with various aspects of the present disclosure.

FIG. 10 is a flowchart of a method of wireless communication at a UE, in accordance with the teachings disclosed herein.

FIG. 11 is a diagram illustrating an example of a hardware implementation for an example apparatus and/or network entity.

FIG. 12 is a flowchart of a method of wireless communication at a network entity, in accordance with the teachings disclosed herein.

FIG. 13 is a diagram illustrating an example of a hardware implementation for an example network entity.

### DETAILED DESCRIPTION

In a wireless communications system, a network may aim to ensure that a UE maintains connectivity with a network entity (e.g., a base station) as the UE moves within a network. Mobility management may enable tracking a UE in order to provide services to the UE. Mobility management may include signaling among different network entities and the UE.

A UE may encounter different types of mobility, such as physical-level mobility, data-level mobility, and network-level mobility. In some examples, the different types of mobility may be associated with different performance costs, such as latency. For example, when a UE performs network-level handover procedure, the network and the UE may use RRC signaling, which may result in the performing of a network-level handover procedure being time consuming and/or inefficient.

In some examples, to help reduce mobility latency, a network and a UE may employ L1/L2 inter-cell mobility. L1/L2 signaling may facilitate inter-cell mobility based on UE-dedicated channels and/or reference signals (RSs). Such mobility may be referred to as “L1/L2 inter-cell mobility,” “L1/L2 based inter-cell mobility,” or “L1/L2 mobility” herein.

In some examples, a network may change the SpCell for a UE, for example, from a first SpCell to a second SpCell. The network may change the SpCell for a UE based on measurements performed by the UE. In some examples, the network may configure the UE to perform measurements. The network may also configure the UE to report the measurements based on the measurement configuration. The network may provide the measurement configuration via RRC signaling.

In some examples, the measurements may include layer 3 (L3) intra-frequency measurements, L3 inter-frequency measurements, and/or L1-RSRP measurements. In some examples, an L3 intra-frequency measurement may be performed when an SSB for a neighboring cell has a same center frequency and a same SCS as an SSB for a serving cell. For example, a measurement performed by the UE may be an L3 intra-frequency measurement when the center frequency of the SSB of the serving cell indicated for measurement and the center frequency of the SSB of a neighboring cell (e.g., a candidate cell) are the same, and the SCS of the two SSBs are also the same. An L3 inter-frequency measurement refers to a measurement when at least one of the center frequency and the SCS of the two SSBs is different.

In some examples, the network may configure the UE to perform an L1-RSRP measurement of measurement objects. The measurement may be performed for a serving cell, including a PCell, a PSCell, or an SCell, on resources configured for L1-RSRP measurements within an active BWP. The active BWP may be part of a configured bandwidth. In some examples, the UE may perform the L1-RSRP measurements for a reference signal in an active BWP without a measurement gap.

However, L1/L2 inter-cell mobility may support both intra-frequency scenarios and inter-frequency scenarios. In some examples, inter-frequency scenarios may be based on a relationship between a candidate measurement object, a configured BW, and an active BWP.

Aspects disclosed herein provide techniques for configuring measurement gaps (or configuring no measurement gaps) for different inter-frequency scenarios, which may improve the efficiency of wireless communications. For example, a UE may receive an L1 measurement configuration for a set of SpCells for L1 or L2 inter-cell mobility. The L1 measurement configuration may be associated with a measurement gap for a measurement object that is located at least at one of: within a configured BW of an activated serving cell and outside an active BWP, outside the configured BW and outside the active BWP, or within the configured BW and the active BWP and with at least one of a center frequency or a subcarrier spacing that is different than a measured measurement object of the activated serving cell. The UE may also perform an L1 measurement for a candidate measurement object based on the L1 measurement configuration. Additionally, the UE may transmit an L1 measurement report based on the L1 measurement.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

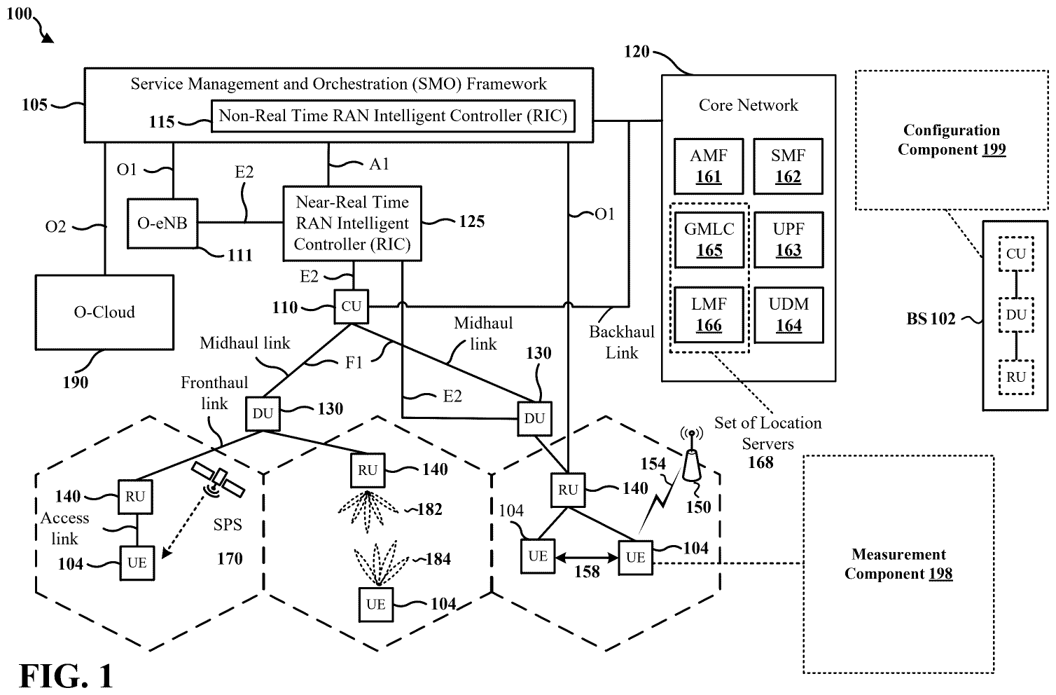

FIG. 1 is a diagram 100 illustrating an example of a wireless communications system and an access network. The illustrated wireless communications system includes a disaggregated base station architecture. The disaggregated base station architecture may include one or more CUs (e.g., a CU 110) that can communicate directly with a core network 120 via a backhaul link, or indirectly with the core network 120 through one or more disaggregated base station units (such as a Near-Real Time (Near-RT) RAN Intelligent Controller (RIC) (e.g., a Near-RT RIC 125) via an E2 link, or a Non-Real Time (Non-RT) RIC 115 associated with a Service Management and Orchestration (SMO) Framework (e.g., an SMO Framework 105), or both). A CU 110 may communicate with one or more DUs (e.g., a DU 130) via respective midhaul links, such as an F1 interface. The DU 130 may communicate with one or more RUs (e.g., an RU 140) via respective fronthaul links. The RU 140 may communicate with respective UEs (e.g., a UE 104) via one or more radio frequency (RF) access links. In some implementations, the UE 104 may be simultaneously served by multiple RUs.

Each of the units, i.e., the CUS (e.g., a CU 110), the DUs (e.g., a DU 130), the RUs (e.g., an RU 140), as well as the Near-RT RICs (e.g., the Near-RT RIC 125), the Non-RT RICs (e.g., the Non-RT RIC 115), and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU 140 can be implemented to handle over the air (OTA) communication with one or more UEs (e.g., the UE 104). In some implementations, real-time and non-real-time aspects of control and user plane communication with the RU 140 can be controlled by a corresponding DU. In some scenarios, this configuration can enable the DU(s) and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs, DUs, RUS and Near-RT RICs. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs (e.g., the RU 140) and the UEs (e.g., the UE 104) may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UE 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication (e.g., a D2D communication link 158). The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with a UE 104 (also referred to as Wi-Fi stations (STAs)) via communication link 154, e.g., in a 5 GHz unlicensed frequency spectrum or the like. When communicating in an unlicensed frequency spectrum, the UE 104/Wi-Fi AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referredto (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referredto as next generation (NG) RAN (NG-RAN).

The core network 120 may include an Access and Mobility Management Function (AMF) (e.g., an AMF 161), a Session Management Function (SMF) (e.g., an SMF 162), a User Plane Function (UPF) (e.g., a UPF 163), a Unified Data Management (UDM) (e.g., a UDM 164), one or more location servers 168, and other functional entities. The AMF 161 is the control node that processes the signaling between the UE 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) (e.g., a GMLC 165) and a Location Management Function (LMF) (e.g., an LMF 166). However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station (e.g., the base station 102). The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a device in communication with a base station, such as a UE 104 in communication with a network entity, such as a base station 102 or a component of a base station (e.g., a CU 110, a DU 130, and/or an RU 140), may be configured to manage one or more aspects of wireless communication. For example, the UE 104 may include a measurement component 198 configured to facilitate performing L1 measurements with measurement gaps requirements in L1/L2 inter-cell mobility scenarios.

In certain aspects, the measurement component 198 may be configured to receive an L1 measurement configuration for a set of SpCells for L1 or L2 inter-cell mobility. The L1 measurement configuration may be associated with a measurement gap for a measurement object that is located at least at one of: within a configured BW of an activated serving cell and outside an active BWP, outside the configured BW and outside the active BWP, or within the configured BW and the active BWP and with at least one of a center frequency or a subcarrier spacing that is different than a measured measurement object of the activated serving cell. The example measurement component 198 may also be configured to perform an L1 measurement for a candidate measurement object based on the L1 measurement configuration. Additionally, the example measurement component 198 may be configured to transmit an L1 measurement report based on the L1 measurement.

In another configuration, a network entity, such as a base station 102 or a component of a base station (e.g., a CU 110, a DU 130, and/or an RU 140), may be configured to manage or more aspects of wireless communication. For example, the base station 102 may include a configuration component 199 configured to facilitate performing L1 measurements with measurement gaps requirements in L1/L2 inter-cell mobility scenarios.

In certain aspects, the configuration component 199 may be configured to output an L1 measurement configuration for a set of SpCells for L1 or L2 inter-cell mobility at a UE. The L1 measurement configuration may be associated with a measurement gap for a measurement object that is located at least at one of: within a configured BW of an activated serving cell and outside an active BWP, outside the configured BW and outside the active BWP, or within the configured BW and the active BWP and with at least one of a center frequency or a subcarrier spacing that is different than a measured measurement object of the activated serving cell. The example configuration component 199 may also be configured to obtain an L1 measurement report based in part on the L1 measurement configuration.

Although the following description provides examples directed to 5G NR (and, in particular, to wireless communications employing mobility), the concepts described herein may be applicable to other similar areas, such as LTE, LTE-A, CDMA, GSM, and/or other wireless technologies, in which mobility management may facilitate wireless communications systems.

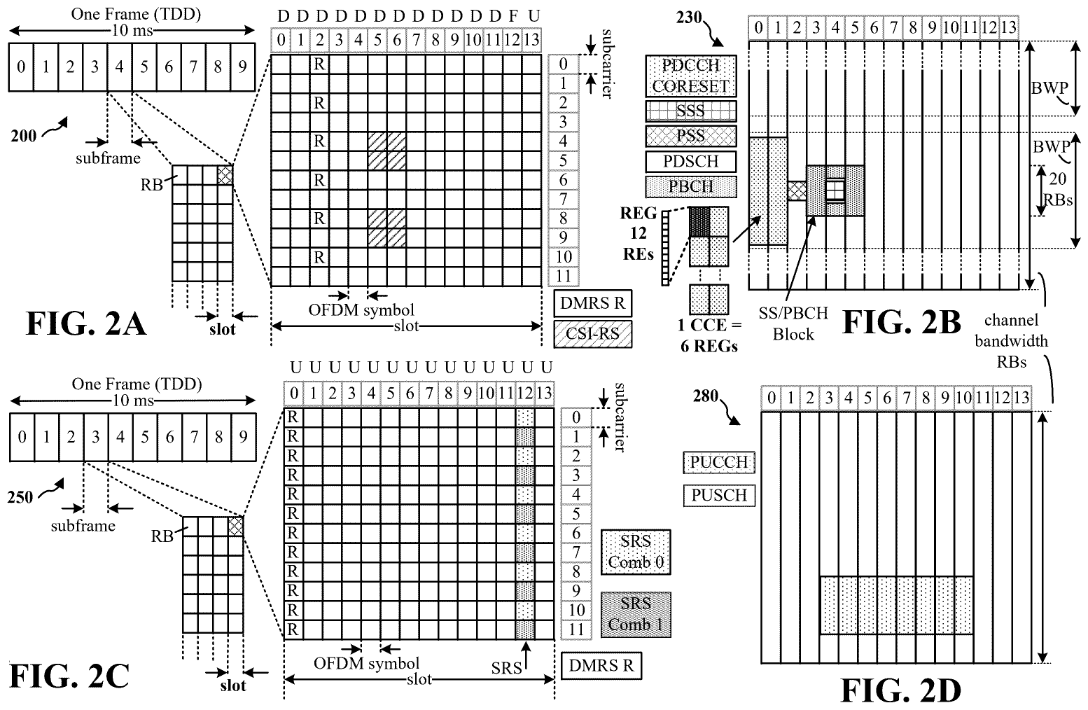

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. As shown in Table 1, the subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

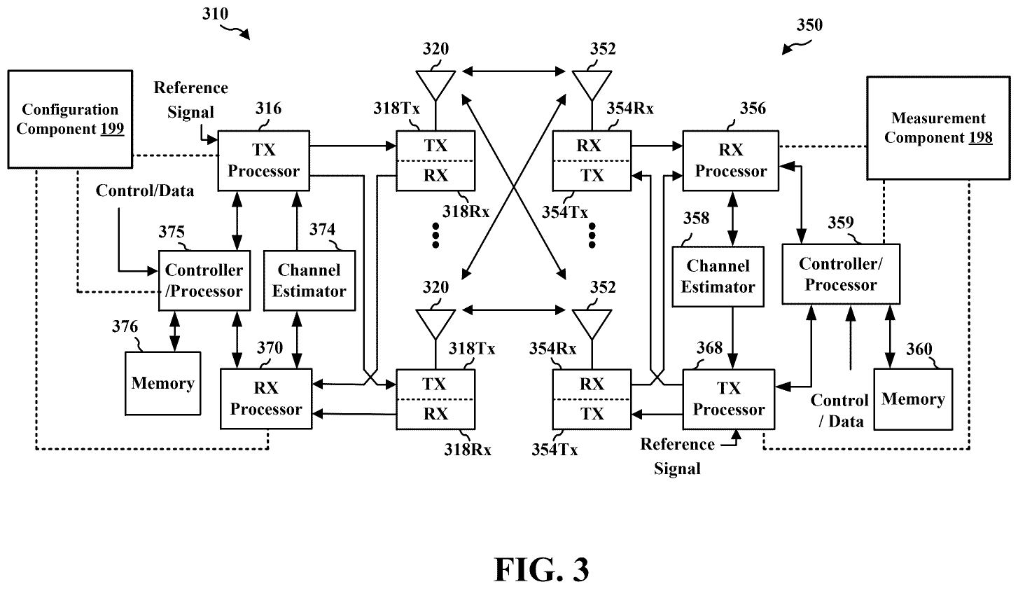

FIG. 3 is a block diagram that illustrates an example of a first wireless device that is configured to exchange wireless communication with a second wireless device. In the illustrated example of FIG. 3, the first wireless device may include a base station 310, the second wireless device may include a UE 350, and the base station 310 may be in communication with the UE 350 in an access network. As shown in FIG. 3, the base station 310 includes a transmit processor (TX processor 316), a transmitter 318Tx, a receiver 318Rx, antennas 320, a receive processor (RX processor 370), a channel estimator 374, a controller/processor 375, and memory 376. The example UE 350 includes antennas 352, a transmitter 354Tx, a receiver 354Rx, an RX processor 356, a channel estimator 358, a controller/processor 359, memory 360, and a TX processor 368. In other examples, the base station 310 and/or the UE 350 may include additional or alternative components.

In the DL, Internet protocol (IP) packets may be provided to the controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 316 and the RX processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna of the antennas 320 via a separate transmitter (e.g., the transmitter 318Tx). Each transmitter 318Tx may modulate a radio frequency (RF) carrier with a respective spatial stream for transmission.

At the UE 350, each receiver 354Rx receives a signal through its respective antenna of the antennas 352. Each receiver 354Rx recovers information modulated onto an RF carrier and provides the information to the RX processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, two or more of the multiple spatial streams may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with the memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna of the antennas 352 via separate transmitters (e.g., the transmitter 354Tx). Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna of the antennas 320. Each receiver 318Rx recovers information modulated onto an RF carrier and provides the information to the RX processor 370.

The controller/processor 375 can be associated with the memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the measurement component 198 of FIG. 1.

At least one of the TX processor 316, the RX processor 370, and the controller/processor 375 may be configured to perform aspects in connection with the configuration component 199 of FIG. 1.

In a wireless communications system, a network may aim to ensure that a UE maintains connectivity with a network entity (e.g., a base station) as the UE moves within a network. Mobility management may enable tracking a UE in order to provide services to the UE. Mobility management may include signaling among different network entities and the UE.

A UE may encounter different types of mobility, such as physical-level mobility, data-level mobility, and network-level mobility. For physical-level mobility (e.g., L1 mobility), a UE may change beams within a same cell. For data-level mobility (e.g., L2 mobility), a UE may be controlled by a same base station, but may perform a handover procedure from a first cell to a second cell. For network-level mobility (e.g., L3 mobility) the UE may perform a handover procedure from a first centralized unit (CU) to a second CU.

In some examples, the different types of mobility may be associated with different performance costs, such as latency. For example, when a UE performs an L3 handover procedure, the network and the UE may use RRC signaling, which may result in the performing of an L3 handover procedure being time consuming and/or inefficient.

In some examples, to help reduce mobility latency, a network and a UE may employ L1/L2 inter-cell mobility. For example, configuration and maintenance of multiple candidate cells may allow for rapid application of configurations for candidate cells. Furthermore, dynamic switching mechanisms among candidate serving cells, including an SpCell and SCell, based on L1/L2 signaling may further reduce latency. Examples of L1/L2 signaling include downlink control information (DCI) and MAC control elements (MAC-CEs). L1/L2 signaling may facilitate inter-cell mobility based on UE-dedicated channels and/or reference signals (RSs). Such mobility may be referred to as “L1/L2 inter-cell mobility,” “L1/L2 based inter-cell mobility,” or “L1/L2 mobility” herein.

The procedures of L1/L2 mobility are applicable to many scenarios. These scenarios may include, for example, standalone CA and NR dual connectivity (NR-DC) cases with serving cell changing within one CG, intra-DU cases and intra-CU inter-DU cases (applicable for standalone and CA, with no new RAN interface expected), intra-frequency and inter-frequency cases, FR1 and FR2 cases. In these scenarios, the source and target cells may be synchronized or non-synchronized.

In some aspects, the network may configure a set of cells for L1/L2 mobility. The set of cells for L1/L2 mobility may be referred to as an L1/L2 mobility configured cell set. A subset of the L1/L2 mobility configured cell set may be activated (e.g., with L1 or L2 control signaling) and may be referred to as an “L1/L2 mobility activated cell set” or as an “activated L1/L2 mobility cell set.” The subset of cells in the L1/L2 mobility configured cell set that are not activated or that are indicated to be deactivated may be referred to as an “L1/L2 mobility deactivated cell set” or as a “deactivated L1/L2 mobility cell set.” The L1/L2 mobility activated cell set may be a group of cells (e.g., a subset of cells) in the L1/L2 mobility configured cell set that are activated and may be readily used for data and control transfer. The L1/L2 mobility deactivated cell set (which may be an L1/L2 mobility candidate cell set) may be a group of cells (e.g., a subset of cells, remaining cells, non-activated cells) in the configured set that are configured for the UE yet deactivated (e.g., not used for data/control transfer until activated) and may be activated by L1/L2 signaling. Once activated, a deactivated cell may be used for data communications and control communications between a UE and a base station.

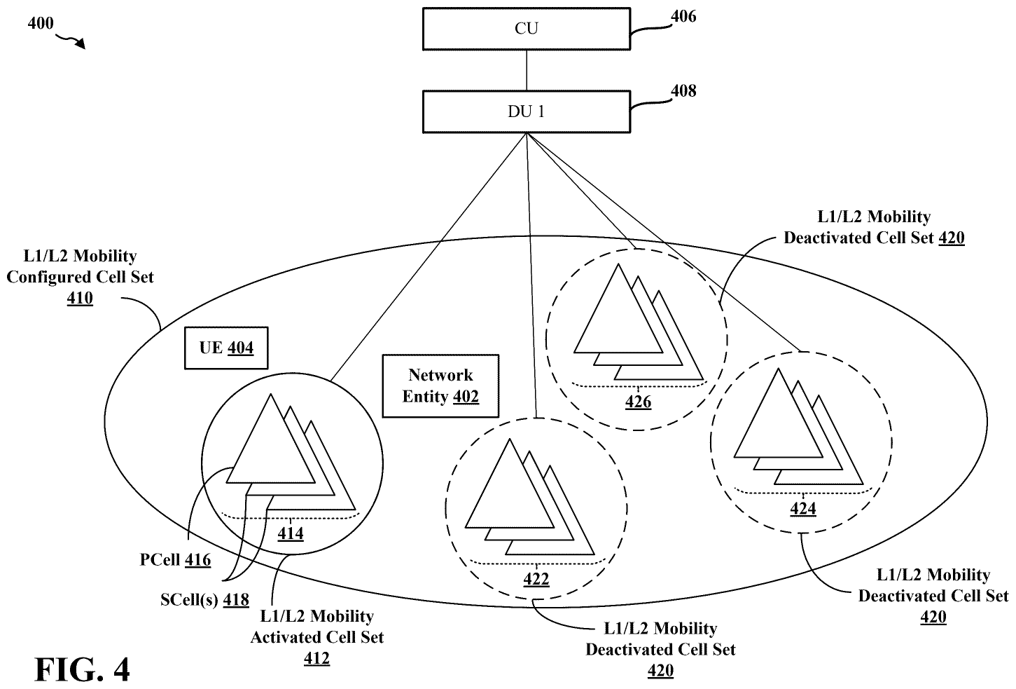

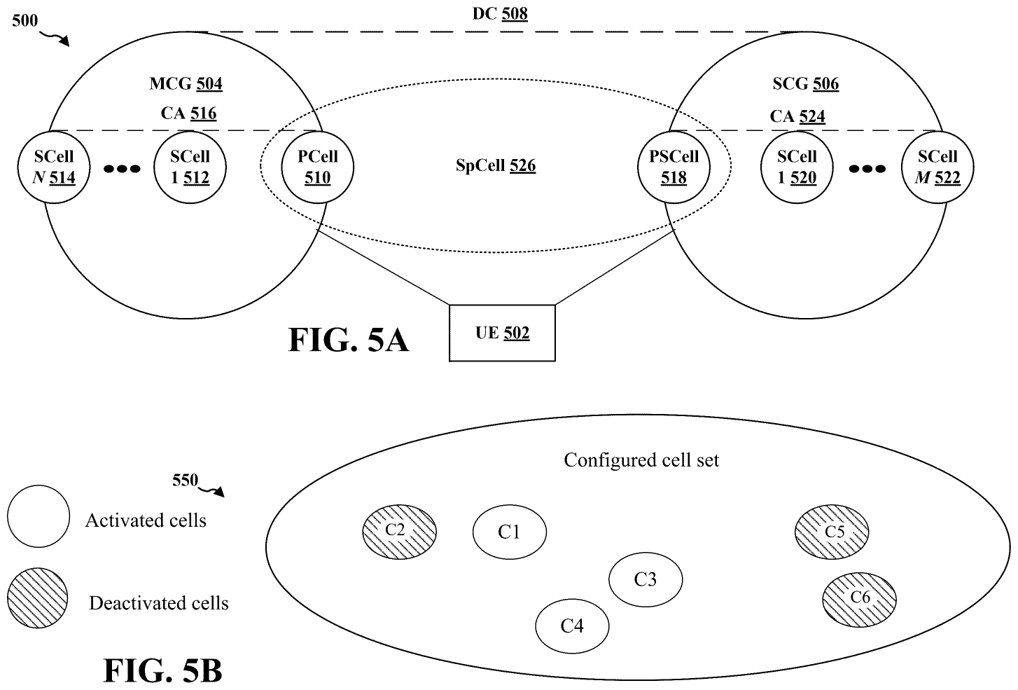

FIG. 4 is a diagram 400 that illustrates an example cell configuration including an L1/L2 mobility configured cell set 410, as presented herein. The L1/L2 mobility configured cell set 410 may be configured to cover a meaningful mobility area. In the diagram 400, a triangle represents a cell and groups of overlapping triangles represent cell groups (e.g., groups of cells or subsets of cells). A network entity 402, such as the base station 102 of FIG. 1 and/or the base station 310 of FIG. 3 may configure, via RRC signaling, the L1/L2 mobility configured cell set 410 for a UE 404, such as the UE 104 of FIG. 1 and/or the UE 350 of FIG. 3. For example, the network entity 402 may configure each cell group within the L1/L2 mobility configured cell set 410 using an L1/L2 mobility cell group configuration (which may be referred to as an “LIL2MobilityCellGroupConfigList” or by any other name). L1/L2 signaling may indicate an activation status of each cell within the L1/L2 mobility configured cell set 410. For example, the network entity 402 may activate and/or deactivate cells from the set using L1/L2 signaling. The activation and/or deactivation may be based on signal quality measurements, loading, etc. In some aspects, the L1/L2 mobility cell group configuration may configure one or more groups of cells for L1/L2 mobility management, for example, and the L1/L2 signaling may activate or deactivate a group of cells. In other aspects, the activation and deactivation may be indicated for individual cells. For example, FIG. 5B illustrates an example diagram 550 in which a set of cells is RRC configured for the UE for L1/L2 mobility, and one or more of the cells may be activated, and a remaining subset of the cells may be deactivated. Similarly, in FIG. 4, in some aspects, the network may indicate that a PCell 416 and one or more SCells 418 are activated, e.g., whether as a group or individually, and the remaining cells may be deactivated, or non-activated, for L1/L2 inter-cell mobility.

As shown in FIG. 4, the L1/L2 mobility configured cell set 410 includes an L1/L2 mobility activated cell set 412. In some examples, the network entity 402 may transmit L1/L2 signaling to the UE 404 that activates (e.g., comprise an indication of an activation) a group of cells either individually indicating that each cell is activated to form an activated group of cells or by indicating that the cells are activated as a group. The L1/L2 mobility activated cell set 412 includes at least one cell that is activated and that can be readily used for data communications and/or control communications. In the illustrated example of FIG. 4, activated cells 414 (and the L1/L2 mobility activated cell set 412) includes a PCell 416. The activated cells 414 (and hence the L1/L2 mobility activated cell set 412) may also include one or more SCells 418.

In some examples, L1/L2 signaling may be used to activate/deactivate cells, for example, either individually or in groups, in the L1/L2 mobility configured cell set 410 and to select beams within the activated cells. There may be seamless mobility within the activated cells. As the UE 404 changes locations, different cells from the L1/L2 mobility configured cell set 410 may be deactivated and activated by L1/L2 signaling. For example, the cells may be deactivated/activated based upon measurements generated by the UE 404 and/or loads on cells. Example measurements may include cell coverage measurements represented by Radio Signal Received Power (RSRP), and quality represented by Radio Signal Received Quality (RSRQ), or other measurements that the UE performs on signals from network entities. In some aspects, the measurements may be L1 measurements such as one or more of an RSRP, an RSRQ, a received signal strength indicator (RSSI), or a signal to noise and interference ratio (SINR) measurement of various signals, such as an SSB, a PSS, an SSS, a broadcast channel (BCH), a DM-RS, CSI-RS, or the like.

The L1/L2 mobility configured cell set 410 may also include cells that are configured yet deactivated for L1/L2 mobility. In some examples, the network entity 402 may output (e.g., transmit) an indication of the L1/L2 mobility deactivated cell set 420 to the UE 404. In other aspects, if a cell is not activated, the cell may be in the deactivated cell set. The L1/L2 mobility deactivated cell set 420 may include at least one cell group that is deactivated and that can be readily activated by L1/L2 signaling. In the illustrated example of FIG. 4, the L1/L2 mobility deactivated cell set 420 includes a second cell group 422, a third cell group 424, and a fourth cell group 426. However, as shown in FIG. 5B, each of the non-activated cells in the configured set of L1/L2 mobility may be considered in the set of deactivated cells. In some examples, the network entity 402 may add cells into the L1/L2 mobility activated cell set 412, remove cells from the L1/L2 mobility activated cell set 412, add cells into the L1/L2 mobility deactivated cell set 420, and/or remove cells from the L1/L2 mobility deactivated cell set 420 using L1/L2 signaling, which may be MAC-CE based or DCI based.

In some aspects, all cells in the L1/L2 mobility configured cell set 410 may belong to the same DU and the cells may be on the same or different carrier frequencies. Cells in the L1/L2 mobility configured cell set 460 may cover a mobility area. For example, in the illustrated example of FIG. 4, a CU 406, which may correspond to a component a base station, such as a gNB, or a component of the network entity 402) may be associated with a DU 408 (“DU 1”). Although not shown in FIG. 4, in other examples, the CU 406 may also be associated with one or more other DUs. The L1/L2 mobility configured cell set 410 may be associated with the DU 408.

A UE may be configured with a set of cells for L1/L2 mobility under the carrier aggregation (CA) framework. The set of the cells for L1/L2 mobility may be RRC configured and may include a single PCell and multiple SCells at a given time. The SCells may be updated as a PCell, for example, changed to a PCell configuration or activated as a PCell, using L1/L2 signaling, and the PCell may be updated as (e.g., changed to) an SCell using L1/L2 signaling. For example, a cell may switch between acting as a PCell and an SCell for the UE.

FIG. 5A is a diagram 500 that illustrates an example of dual connectivity and carrier aggregation (CA), as presented herein. A UE 502 may be connected to a master cell group (e.g., an MCG 504) and a secondary cell group (e.g., an SCG 506). Such an arrangement may be referred to as a dual connectivity (DC) arrangement (e.g., a DC arrangement 508). The MCG 504 may be a group of serving cells associated with a master node that has a control plane connection to a core network (e.g., the core network 120 of FIG. 1). The master node may be a network entity (e.g., a base station, such as a gNB, an eNB, etc.). The SCG 506 may be a group of serving cells associated with a secondary node that does not have a control plane connection to the core network. The secondary node may be a network entity (e.g., a base station, such as a gNB, an eNB, etc.). The MCG 504 may become the SCG 506 and the SCG 506 may become the MCG 504 based upon various factors, such as a location of the UE 502, network conditions, etc.

In the illustrated example of FIG. 5A, the MCG 504 includes a PCell 510. The MCG 504 may also include one or more SCells (e.g., a first SCell 512, . . . and an Nth SCell 514, where N is a positive integer greater than one). The PCell 510, the first SCell 512, and/or the Nth SCell 514 may be in a CA configuration 516. In some aspects, a primary cell may become a secondary cell or a secondary cell may become a primary cell based upon various factors, such as a location of the UE 502, network conditions, etc.

In the illustrated example of FIG. 5A, the SCG 506 includes a primary secondary cell (e.g., a PSCell 518). The PSCell 518 is a primary cell of the SCG 506. The SCG 506 may also include one or more SCells (e.g., a first SCell 520, . . . and an Mth SCell 522, where M is a positive integer greater than one). The PSCell 518, the first SCell 520, and/or the Mth SCell 522 may be in a CA configuration 524. In some aspects, a primary secondary cell may become a secondary cell or a secondary cell may become a primary secondary cell based upon various factors, such as a location of the UE 502, network conditions, etc.

The PCell 510 of the MCG 504 and the PSCell 518 of the SCG 506 may be referred to as a special cell (e.g., an SpCell 526). For dual connectivity operation, the term SpCell refers to the PCell of the MCG or the PSCell of the SCG, for example, depending on whether a MAC entity is associated to the MCG or the SCG, respectively. An SpCell supports PUCCH transmission and contention-based random access, and is always activated. The SpCell 526 is responsible for data channel and control channel functionality. In cases in which there is no dual connectivity (e.g., when only the MCG 504 is configured and when the SCG 506 is not configured), the PCell 510 may be referred to as the SpCell 526. A cell group that includes the SpCell 526 may be referred to as a PCG.

It is to be understood that an SpCell may change based upon various factors, such as a location of the UE 502, network conditions, etc. In an example, a network entity may configure the first SCell 512 as a primary cell and the Mth SCell 522 as a primary secondary cell to configure a new SpCell.

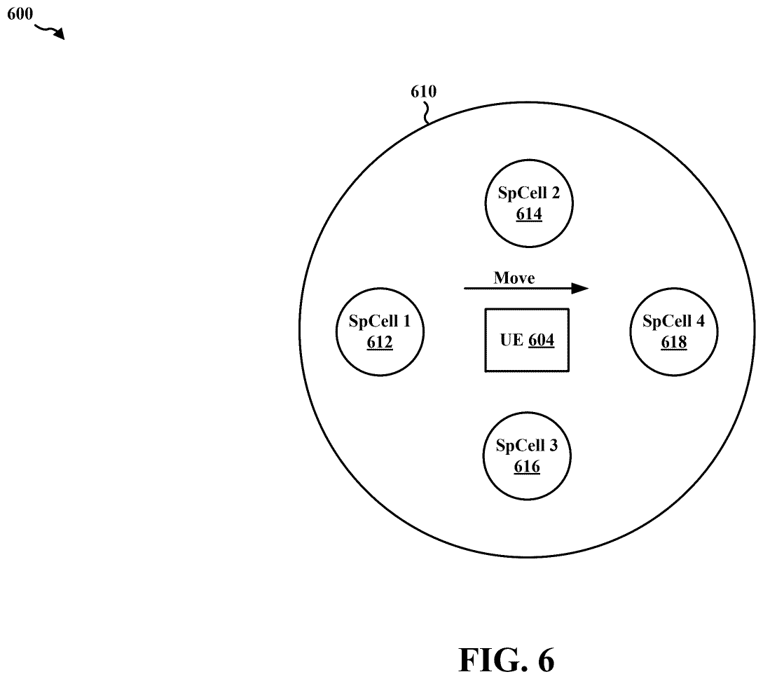

As described above, a network may change the SpCell, for example, from a first SpCell to a second SpCell. FIG. 6 depicts a diagram 600 illustrating a single SpCell change without carrier aggregation, as presented herein. In the example of FIG. 6, a UE 604 may be configured with a candidate SpCell set 610. The candidate SpCell set 610 includes an active SpCell 612 (“SpCell 1”), a first candidate SpCell 614 (“SpCell 2”), a second candidate SpCell 616 (“SpCell 3”), and a third candidate SpCell 618 (“SpCell 4”). The active SpCell 612 may be the serving cell with which the UE 604 is in communication. As shown in FIG. 6, the UE 604 is moving away from the active SpCell 612 and, thus, may switch to one of the candidate SpCells using L1/L2 inter-cell mobility. For example, the UE 604 may perform a handover procedure from the active SpCell 612 to the third candidate SpCell 618.

The network may change the SpCell for a UE based on measurements performed by the UE. In some examples, the network may configure the UE to perform measurements. The network may also configure the UE to report the measurements based on the measurement configuration. The network may provide the measurement configuration via RRC signaling.

The measurement configuration may include one or more parameters that configure the UE to perform one or more types of measurements and configure the information provided by the UE in measurement reports. For example, the measurement configuration may include measurement objects, reporting configurations, and measurement gaps. The measurement objects may be indicated via a list of objects (e.g., SSBs, CSI-RS, etc.) on which the UE is to perform the measurements. For intra-frequency measurements and/or inter-frequency measurements on a measurement object, the measurement object may indicate the frequency/time location and subcarrier spacing (SCS) of reference signals to be measured. The reporting configurations may include a list reporting configurations and where a measurement object may be associated with one or more reporting configurations. Each reporting configuration may include a reporting criterion that triggers the UE to send a measurement report, a reference signal (RS) type for the RS that the UE uses for beam and cell measurement results (e.g., SSBs, CSI-RS, etc.), and a reporting format. The measurement gaps may indicate periods that the UE may use to perform measurements.

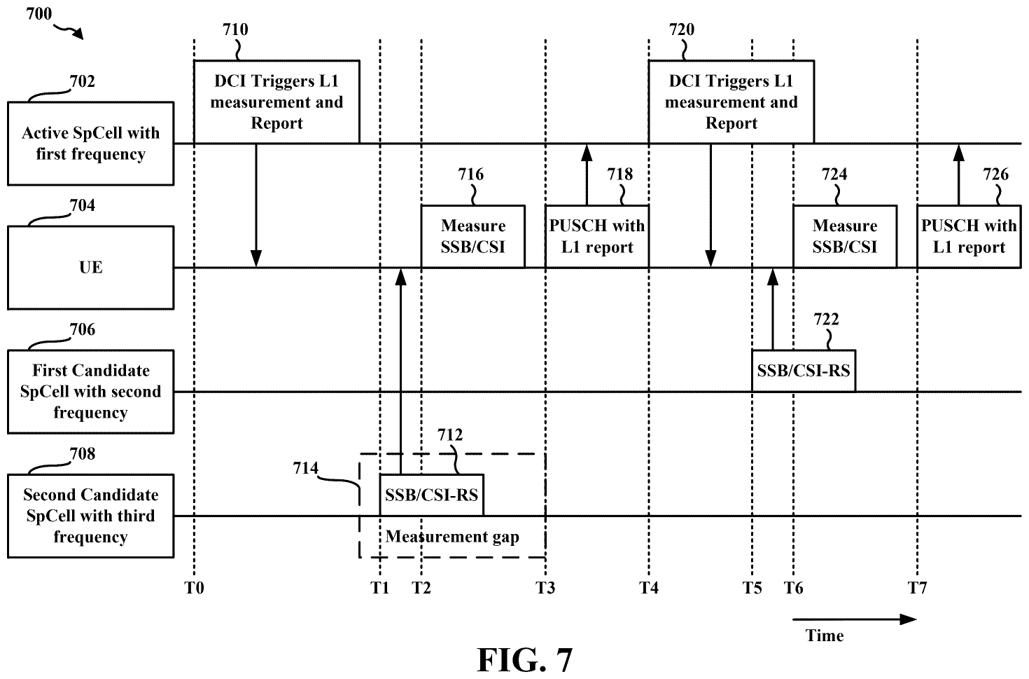

FIG. 7 depicts a timing diagram 700 that illustrates communications between an active SpCell 702 and a UE 704, as presented herein. The communications may facilitate performing an SpCell change from the active SpCell 702 to a first candidate SpCell 706 or a second candidate SpCell 708. As shown in FIG. 7, the active SpCell 702 operates in a first frequency, the first candidate SpCell 706 operates in a second frequency, and the second candidate SpCell 708 operates in a third frequency. When the first frequency and the frequency of a candidate SpCell is the same, the active SpCell 702 and the respective SpCell may be referred to as intra-frequency cells. For example, the first frequency associated with the active SpCell 702 and the second frequency associated with the first candidate SpCell 706 may be a same frequency and, thus, the active SpCell 702 and the first candidate SpCell 706 may be referred to as intra-frequency cells. Otherwise, the active SpCell 702 and the respective SpCell may be referred to as inter-frequency cells. For example, the first frequency associated with the active SpCell 702 and the third frequency associated with the second candidate SpCell 708 may be different frequencies and, thus, the active SpCell 702 and the second candidate SpCell 708 may be referred to as inter-frequency cells.

In the illustrated example of FIG. 7, the active SpCell 702 outputs (e.g., transmits) a first DCI 710 at time TO that is received by the UE 704. The first DCI 710 may trigger the UE 704 to perform an L1 measurement and report for a first measurement object 712 output by the second candidate SpCell 708. In the example of FIG. 7, the first measurement object 712 may include an SSB and/or a CSI-RS. The second candidate SpCell 708 may output the first measurement object 712 at time T1 that is received by the UE 704. At time T2, the UE 704 may perform a measurement procedure 716 to measure the first measurement object 712. The UE 704 may then transmit PUSCH 718 at time T3 that is obtained (e.g., received) by the active SpCell 702. The PUSCH 718 may include an L1 report based on the measurement performed on the first measurement object 712 via the measurement procedure 716. As shown in FIG. 7, the first measurement object 712 is associated with a measurement gap 714. The measurement gap 714 may be configured by the active SpCell 702 for the first measurement object 712 and correspond to a period (e.g., guard symbols and/or a guard window) during which the UE 704 may perform the measurement procedure 716 for the first measurement object 712.

In the illustrated example of FIG. 7, the active SpCell 702 may output a second DCI 720 at time T4 that is received by the UE 704. The second DCI 720 may trigger the UE 704 to perform an L1 measurement and report for a second measurement object 722 output by the first candidate SpCell 706. In the example of FIG. 7, the second measurement object 722 may include an SSB and/or a CSI-RS. The first candidate SpCell 706 may output the second measurement object 722 at time T5 that is received by the UE 704. At time T6, the UE 704 may perform a measurement procedure 724 to measure the second measurement object 722. The UE 704 may then transmit PUSCH 726 at time T7 that is obtained by the active SpCell 702. The PUSCH 726 may include an L1 report based on the measurement performed on the second measurement object 722 via the measurement procedure 724. As shown in FIG. 7, the second measurement object 722 is not associated with a measurement gap and, thus, the UE 704 may perform the measurement procedure 724 without waiting for a configured period (e.g., without waiting for a configured measurement gap).

In some examples, the measurements may include L3 intra-frequency measurements, L3 inter-frequency measurements, and/or L1-RSRP measurements. In some examples, an L3 intra-frequency measurement may be performed when an SSB for a neighboring cell has a same center frequency and a same SCS as an SSB for a serving cell. For example, a measurement performed by the UE may be an L3 intra-frequency measurement when the center frequency of the SSB of the serving cell indicated for measurement and the center frequency of the SSB of a neighboring cell (e.g., a candidate cell) are the same, and the SCS of the two SSBs are also the same. An L3 inter-frequency measurement refers to a measurement when at least one of the center frequency and the SCS of the two SSBs is different.

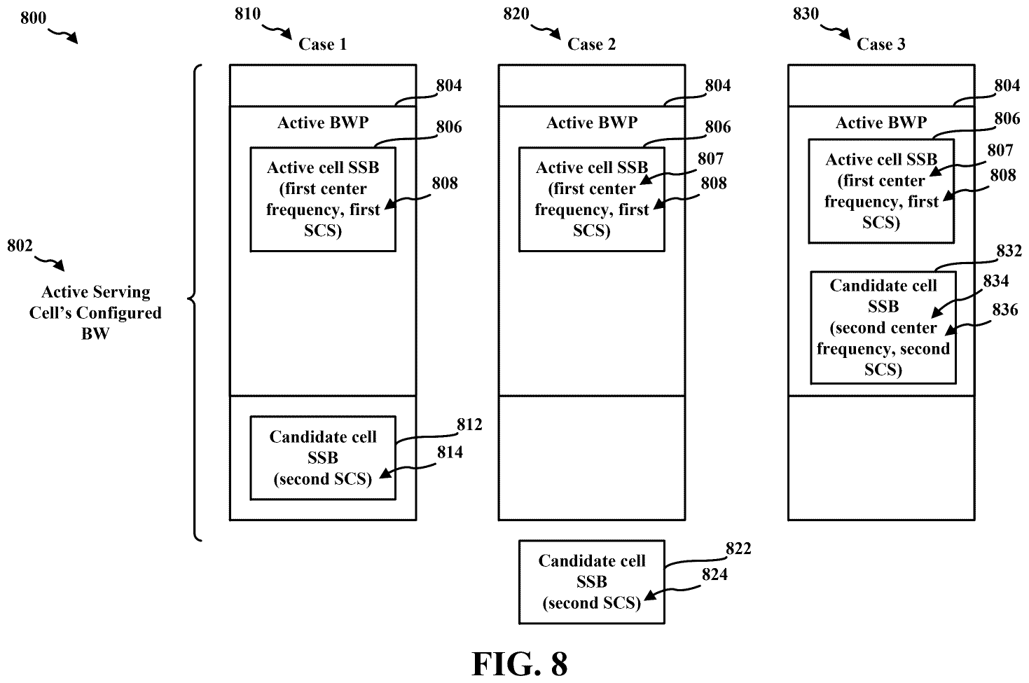

In some examples, the network may configure the UE to perform an L1-RSRP measurement of measurement objects. The measurement may be performed for a serving cell, including a PCell, a PSCell, or an SCell, on resources configured for L1-RSRP measurements within an active BWP. The active BWP may be part of a configured bandwidth. In some examples, the UE may perform the L1-RSRP measurements for a reference signal in an active BWP without a measurement gap. However, as described above, L1/L2 inter-cell mobility may support both intra-frequency scenarios and inter-frequency scenarios. FIG. 8 is a diagram 800 that illustrates three examples of inter-frequency scenarios that may be supported for L1/L2 inter-cell mobility, as presented herein. A UE may be configured with a bandwidth 802 (BW) to support communications with an active serving cell (e.g., the active SpCell 612 of FIG. 6 and/or the active SpCell 702 of FIG. 7). However, to improve communication perform and to reduce monitoring resources at the UE, the bandwidth 802 may include one or more bandwidth parts (BWPs). A BWP may include a contiguous subset of physical resource blocks selected from contiguous set of common resource blocks on a given carrier. Each BWP may include a respective subcarrier spacing, a respective symbol duration, and a respective cyclic prefix (CP) length. A UE may be configured with an active BWP that the UE may monitor and/or use to receive and/or transmit communications.

As shown in FIG. 8, the bandwidth 802 includes an active BWP 804. Additionally, the active serving cell may output an active cell SSB 806 that is located within the active BWP 804 of the bandwidth 802. The active cell SSB 806 may be associated with a first center frequency 807 and a first SCS 808.

In a first scenario 810 (“Case 1”), a first candidate cell SSB 812 may be located outside the active BWP 804, but within the bandwidth 802. In a second scenario 820 (“Case 2”), a second candidate cell SSB 822 may be located outside the active BWP 804 and outside the bandwidth 802. In a third scenario 830 (“Case 3”), a third candidate cell SSB 832 may be located within the active BWP 804, but with a center frequency and/or an SCS that is different from an SSB of the active serving cell. For example, the third candidate cell SSB 832 may be associated with a second center frequency 834 and a second SCS 836. In the example of the third scenario 830, the second center frequency 834 may be different than the first center frequency 807 of the active cell SSB 806 and/or the second SCS 836 may be different than the first SCS 808 of the active cell SSB 806.

In some such scenarios, it may be beneficial to support L1 intra-frequency measurements and L1 inter-frequency measurements to support L1/L2 inter-cell mobility. As used herein, an L1 inter-frequency measurement may refer to a measurement in which any of the example scenarios of FIG. 8 are true. For example, an L1 inter-frequency measurement may include a measurement of the first candidate cell SSB 812 that is located outside the active BWP 804, but within the bandwidth 802 of the active serving cell, as shown in the first scenario 810. In another example, an L1 inter-frequency measurement may include a measurement of the second candidate cell SSB 822 that is located outside the active BWP 804 and outside the bandwidth 802, as shown in the second scenario 820. In another example, an L1 inter-frequency measurement may include a measurement of the third candidate cell SSB 832 that is located within the active BWP 804, but with a center frequency and/or an SCS that is different from the active cell SSB 806, as shown in the third scenario 830. In another example, an L1 inter-frequency measurement may include a measurement of a candidate cell SSB has a different center frequency and/or a different SCS from SSBs of any activated serving cell (e.g., any serving cells included in the L1/L2 mobility activated cell set 412 of FIG. 4). It may be understood that an L1 intra-frequency scenario may refer to a measurement in which the four above examples related to L1 inter-frequency measurements are not true.

It may be understood that when performing an L1 inter-frequency measurement, it may be beneficial to determine whether to include a measurement gap (e.g., as shown in connection with the first measurement object 712 of FIG. 7) or not to include a measurement gap (e.g., as shown in connection with the second measurement object 722 of FIG. 7). In some examples, the inclusion or exclusion of a measurement gap may be frequency band dependent, may be band combination (BC) dependent, and/or may be frequency range (FR) dependent. Additionally, or alternatively, the inclusion or exclusion of a measurement gap may be SSB center frequency dependent and/or SSB SCS dependent.

In some examples, the inclusion or exclusion of a measurement gap associated with a measurement object may be capability-based or rule-based. In a rule-based scenario, a first option is that a measurement gap is always configured. In such examples, the measurement configuration associated with the measurement object may always include a measurement gap. In a second option, the UE may be configured to support performing measurements without a measurement gap and, thus, the measurement configuration associated with the measurement object may skip including a measurement gap. In a third option, the UE may be configured to treat such scenarios as an error case. For example, if a UE is configured to perform a measurement on a measurement object that satisfies one of the examples of an L1 inter-frequency measurement, the UE may ignore the measurement object and skip providing a measurement report for the respective measurement object.

In some examples, the inclusion or exclusion of a measurement gap associated with a measurement object may be capability-based. For example, the UE may transmit a capability indicating an ability of the UE to support performing a measurement without a measurement gap. In some such examples, the network entity may configure a measurement of a measurement object with or without a measurement gap based on the capability provided by the UE.

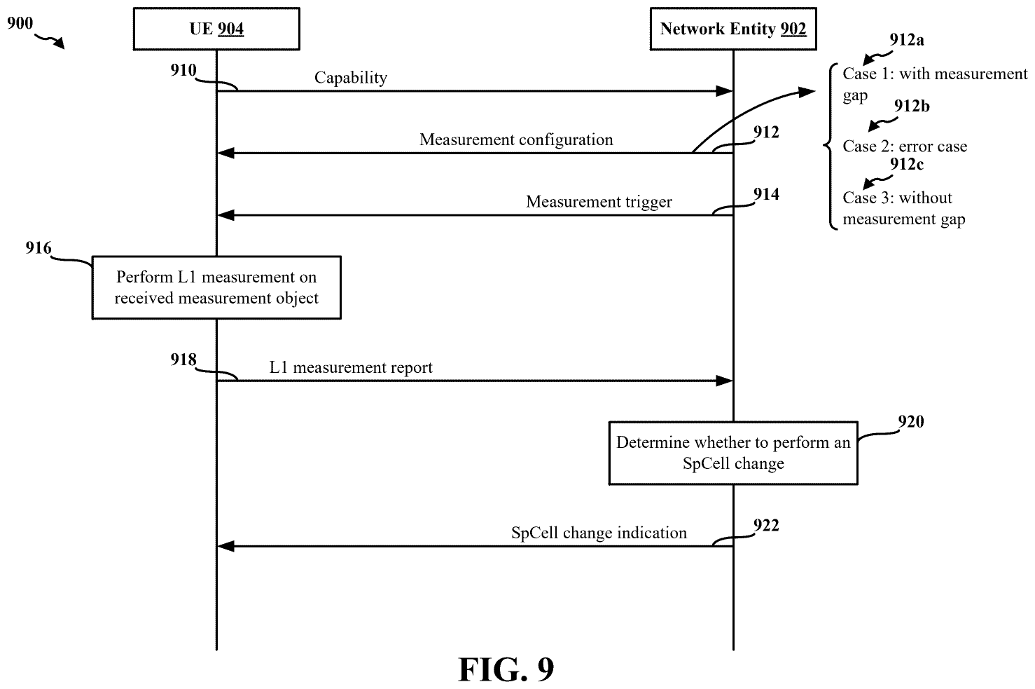

FIG. 9 illustrates an example communication flow 900 between a network entity 902 and a UE 904, as presented herein. One or more aspects described for the network entity 902 may be performed by a component of a base station or a network entity, such as a CU, a DU, and/or an RU. In the illustrated example, the communication flow 900 facilitates performing L1 measurements with measurement gaps requirements in L1/L2 inter-cell mobility scenarios.

Aspects of the network entity 902 may be implemented by the base station 102 of FIG. 1 and/or the base station 310 of FIG. 3. Aspects of the UE 904 may be implemented by the UE 104 of FIG. 1 and/or the UE 350 of FIG. 3. Although not shown in the illustrated example of FIG. 9, in other examples, the network entity 902 and/or the UE 904 may be in communication with one or more other base stations or UEs.

As shown in FIG. 9, the network entity 902 may output (e.g., transmit or output for transmission) a measurement trigger 914 that is received by the UE 904. The measurement trigger 914 may cause the UE 904 to perform a measurement procedure 916 for a measurement object. Aspects of the measurement trigger 914 may be similar to the first DCI 710 and/or the second DCI 720 of FIG. 7.

In the example of FIG. 9, the UE 904 may perform the measurement procedure 916 to perform an L1 measurement on a received measurement object. Aspects of the measurement procedure 916 may be similar to the measurement procedure 716 and/or the measurement procedure 724 of FIG. 7. For example, the UE 904 may measure an RSRP measurement, an RSRQ measurement, an RSSI measurement, or an SINR measurement of various signals, such as an SSB and/or a CSI-RS. The received measurement object may be configured via the measurement trigger 914. In some examples, the received measurement object may correspond to a measurement object output by an activated SpCell, such as the active cell SSB 806 of FIG. 8. In other examples, the received measurement object may correspond to a measurement object output by a candidate SpCell, such as the first measurement object 712 and/or the second measurement object 722 of FIG. 7, and/or the first candidate cell SSB 812, the second candidate cell SSB 822, and/or the third candidate cell SSB 832 of FIG. 8.

After performing the measurement procedure 916, the UE 904 may transmit an L1 measurement report 918 that is obtained (e.g., received) by the network entity 902. The measurement report 918 may include the measurement generated by the UE 904 via the measurement procedure 916. The network entity 902 may perform a determining procedure 920 to determine whether to perform an SpCell change for the UE 904. For example, the network entity 902 may compare the measurement included in the measurement report 918 to other measurements associated with other SpCells (e.g., the activated SpCell and/or candidate SpCells) to determine whether to perform an SpCell change at the UE 904. In examples in which the network entity 902 determines to perform an SpCell change (e.g., via the determining procedure 920), the network entity 902 may output an SpCell change indication 922 that is received by the UE 904. The SpCell change indication 922 may indicate to the UE 904 to perform an SpCell change, for example, from the active SpCell to a candidate SpCell. For example, and referring to the example of FIG. 6, the UE may perform a handover procedure from the active SpCell 612 to the third candidate SpCell 618.

In some examples, the inclusion or exclusion of a measurement gap may be frequency band dependent, may be BC dependent, and/or may be FR dependent. Additionally, or alternatively, the inclusion or exclusion of a measurement gap may be SSB center frequency dependent and/or SSB SCS dependent.

As described above, in some examples, the inclusion or exclusion of a measurement gap for a measurement object may be rule-based. For example, as shown in FIG. 9, the network entity 902 may output a measurement configuration 912 that is received by the UE 904. The measurement configuration 912 may configure the UE 904 with one or more rules to apply when performing the measurement procedure 916 for a received measurement object. For example, the measurement configuration 912 may indicate that the UE 904 is to always use a measurement gap when performing a measurement. In another example, the measurement configuration 912 may indicate that the UE 904 is to skip using a measurement gap when performing a measurement gap. In another example, the measurement configuration 912 may indicate that the UE 904 is to skip performing a measurement one a received measurement gap.

In the example of FIG. 9, the measurement configuration 912 includes different rules to apply based on the different scenarios of FIG. 8. For example, the measurement configuration 912 includes a first rule 912a that indicates that when a first scenario (“Case 1”) is applicable, the UE 904 is to use a measurement gap for performing the measurement on a received measurement object. For example, and referring to the first scenario 810 of FIG. 8, based on the first rule 912a, the UE 904 is to use a measurement gap when performing the measurement procedure 916 on the first candidate cell SSB 812.

As shown in FIG. 9, the measurement configuration 912 includes a second rule 912b that indicates that when a second scenario (“Case 2”) is applicable, the UE 904 is to treat the received measurement object as an error case. For example, and referring to the second scenario 820 of FIG. 8, based on the second rule 912b, the UE 904 is to skip performing the measurement procedure 916 on the second candidate cell SSB 822.

In the illustrated example of FIG. 9, the measurement configuration 912 includes a third rule 912c that indicates that when a third scenario (“Case 3”) is applicable, the UE 904 is to skip using a measurement gap when performing a measurement on a received object. For example, and referring to the third scenario 830 of FIG. 8, based on the third rule 912c, the UE 904 is to perform the measurement procedure 916 on the third candidate cell SSB 832 without a measurement gap.

Although the example of FIG. 9 includes three different rules for the three different scenarios of FIG. 8, in other examples, a rule may be applied for one or more of the different scenarios. For example, a first rule may apply to the first scenario and the second scenario and a second rule may apply to the third scenario. Additionally, or alternatively, the rules may be more granular and may be frequency band dependent, BC dependent, and/or FR dependent. For example, for the first scenario in which a candidate cell SSB is outside an active BWP, but within a configured BW, the measurement configuration 912 may include a first rule for a first frequency band, a second rule for a second frequency band, etc.

As described above, in some examples, the inclusion or exclusion of a measurement gap for a measurement object may be capability-based. For example, the UE 904 may output a capability 910 that is received by the network entity 902. The capability 910 may indicate that the UE 904 has the ability to perform the measurement procedure 916 with or without measurement gaps. In some examples, the network entity 902 may configure the measurement configuration 912 based on the capabilities of the UE 904 indicated by the capability 910.

In some examples, the capabilities indicated by the UE 904 may be based on the different inter-frequency scenarios of FIG. 8. For example, and referring to the first scenario 810 of FIG. 8 in which the first candidate cell SSB 812 is located within the bandwidth 802 and outside the active BWP 804, the capabilities of the UE 904 may depend on whether the first candidate cell SSB 812 has a same or different SCS as the active cell SSB 806. For example, the capability 910 may indicate that the UE 904 supports performing measurements without measurement gaps when a second SCS 814 of the first candidate cell SSB 812 is the same SCS as the first SCS 808 of the active cell SSB 806. Additionally, or alternatively, the capabilities of the UE 904 may depend on whether an active cell SSB is located inside or outside the active BWP 804. For example, if the UE 904 supports no SSBs inside an active BWP, then the capability 910 may indicate that the UE 904 supports performing measurements without measurement gaps on a candidate cell SSB when the active cell SSB is located outside the active BWP 804. In some examples, the capability 910 may be based on a combination of factors. For example, the capability 910 may indicate that the UE 904 supports performing measurements without measurement gaps for L1 measurement if the UE 904 supports no SSBs inside an active BWP and a candidate cell SSB has a same SCS as an active serving cell SSB.

Referring to the second scenario 820 of FIG. 8 in which the second candidate cell SSB 822 is located outside the active BWP 804 and the bandwidth 802, the capabilities of the UE 904 indicated by the capability 910 may be indicated per measured SSB frequency, per cell, or per frequency band containing a candidate cell SSB. In some examples, the capabilities indicated by the UE 904 may depend on whether carrier aggregation is supported and/or a candidate cell configuration (e.g., provided by the network entity 902). In some examples, the capabilities indicated by the UE 904 may depend on whether a candidate cell SSB has a same SCS or different SCS as an active cell SSB. For example, the capability 910 may indicate that the UE 904 supports performing measurements without measurement gaps when a second SCS 824 of the second candidate cell SSB 822 is the same SCS as the first SCS 808 of the active cell SSB 806. Additionally, or alternatively, the capabilities of the UE 904 may depend on whether an active cell SSB is located inside or outside the active BWP 804. For example, if the UE 904 supports no SSBs inside an active BWP, then the capability 910 may indicate that the UE 904 supports performing L1 measurements without measurement gaps on a candidate cell SSB when the active cell SSB is located outside the active BWP 804. In some examples, the capability 910 may be based on a combination of factors.

Referring to the third scenario 830 of FIG. 8 in which the third candidate cell SSB 832 is located inside the active BWP 804, but with a center frequency and/or an SCS that is different from an SSB of the active serving cell, the capabilities of the UE 904 indicated by the capability 910 may be indicated per measured SSB frequency, per cell, or per frequency band containing a candidate cell SSB. In some examples, the capabilities indicated by the UE 904 may depend on whether carrier aggregation is supported and/or a candidate cell configuration (e.g., provided by the network entity 902). Additionally, or alternatively, the capabilities of the UE 904 may depend on whether an active cell SSB is located inside or outside the active BWP 804. For example, if the UE 904 supports no SSBs inside an active BWP, then the capability 910 may indicate that the UE 904 supports performing L1 measurements without measurement gaps on a candidate cell SSB when the active cell SSB is located outside the active BWP 804. In some examples, the capability 910 may be based on a combination of factors.

In some examples, the capability 910 may be indicated via a new capability indication. In other examples, the capability 910 may be indicated via an existing capability indication (e.g., for L3 measurement). For example, and referring to the second scenario 820 of FIG. 8, the capability 910 may be indicated via a need for gaps indication (which may be referred to as a “NeedForGapsInfoNR” information element, a “NeedForGapsInfoNR-r16” information element, or by another name). The need for gaps indication may indicate whether a measurement gap is required for the UE 904 to perform SSB based L1 measurements on an NR target band. The need for gaps indication may include an intra-frequency field (which may be referred to as an “intraFreq-needForGap” field, an “intraFreq-needForGap-r16” field, or by another name) and an inter-frequency field (which may be referred to as an “interFreq-needForGap” field, an “interFreq-needForGap-r16” field or by another name). The intra-frequency field may indicate the measurement gap requirement for NR L1 intra-frequency measurements. The inter-frequency field may indicate the measurement gap requirement for NR L1 inter-frequency measurements.

Referring to the third scenario 830 of FIG. 8, the capability 910 may be indicated via an inter-frequency measurement parameter (which may be referred to as a “interFrequencyMeas-NoGap” parameter, a “interFrequencyMeas-NoGap-r16” parameter, or by another name). The inter-frequency measurement parameter may indicate whether the UE has the ability to perform inter-frequency SSB based measurements without measurement gaps if the SSB is completely contained in the active BWP (e.g., the active BWP 804 of FIG. 8) of the UE. In some examples, the inter-frequency measurement parameter may be indicated for FR1 and FR2 differently. In some such examples, each indication may correspond to the respective frequency range of cells to be measured.

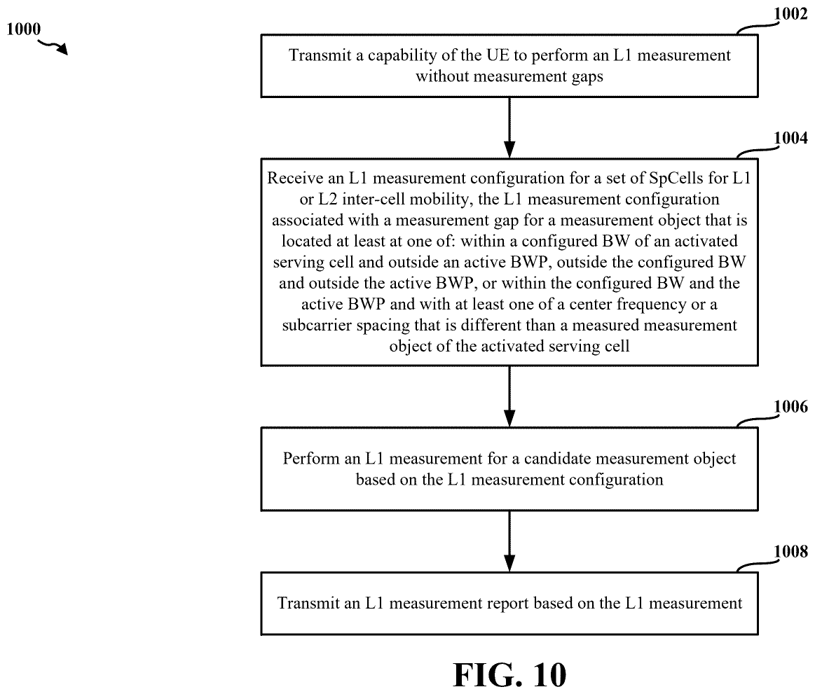

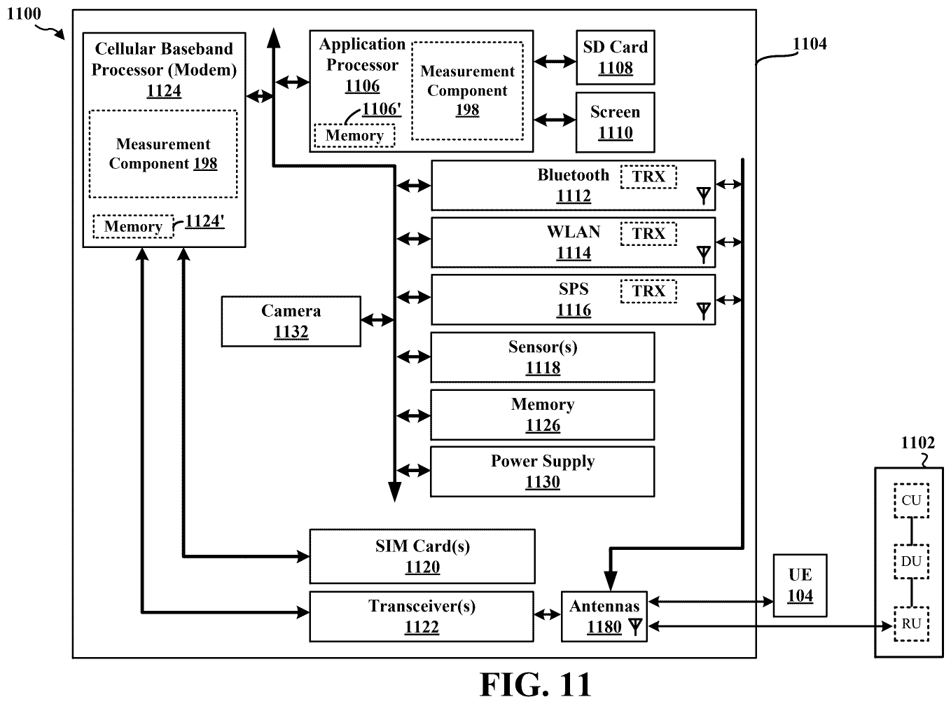

FIG. 10 is a flowchart 1000 of a method of wireless communication. The method may be performed by a UE (e.g., the UE 104, and/or an apparatus 1104 of FIG. 11). The method may facilitate performing L1 measurements with measurement gaps requirements in L1/L2 inter-cell mobility scenarios. Thus, the method may facilitate improving the efficiency of wireless communications.

At 1004, the UE receives an L1 measurement configuration for a set of SpCells for L1 or L2 inter-cell mobility, as described in connection with the measurement configuration 912 of FIG. 9. The L1 measurement configuration may be associated with a measurement gap for a measurement object that is located at least at one of: within a configured BW of an activated serving cell and outside an active BWP, outside the configured BW and outside the active BWP, or within the configured BW and the active BWP and with at least one of a center frequency or a subcarrier spacing that is different than a measured measurement object of the activated serving cell, as described in connection with the first scenario 810, the second scenario 820, and the third scenario 830 of FIG. 8. The receiving of the L1 measurement configuration, at 1004, may be performed by a cellular RF transceiver 1122/the measurement component 198 of the apparatus 1104 of FIG. 11.

At 1006, the UE performs an L1 measurement for a candidate measurement object based on the L1 measurement configuration, as described in connection with the measurement procedure 916 of FIG. 9. The performing of the L1 measurement, at 1006, may be performed by the measurement component 198 of the apparatus 1104 of FIG. 11.

At 1008, the UE transmits an L1 measurement report based on the L1 measurement, as described in connection with the measurement report 918 of FIG. 9. The transmitting of the L1 measurement report, at 1008, may be performed by the cellular RF transceiver 1122/the measurement component 198 of the apparatus 1104 of FIG. 11.

In some examples, the L1 measurement configuration (e.g., at 1002) is at least one of capability-based or rule-based.

In some examples in which the L1 measurement configuration is capability-based, the UE may transmit, at 1002, a capability of the UE to perform the L1 measurement without measurement gaps, as described in connection with the capability 910 of FIG. 9. The transmitting of the capability, at 1002, may be performed by the cellular RF transceiver 1122/the measurement component 198 of the apparatus 1104 of FIG. 11.

In some examples, the L1 measurement configuration (e.g., at 1004) may indicate whether the UE is to perform the L1 measurement with or without the measurement gaps based on the capability.

In some examples, the capability of the UE (e.g., at 1002) may be based on at least one of a comparison of a first subcarrier spacing associated with the candidate measurement object and a second subcarrier spacing associated with the measured measurement object when the candidate measurement object is located within the configured BW and outside the active BWP, as described in connection with the first scenario 810 of FIG. 8.

In some examples, the capability of the UE (e.g., at 1002) may be based on at least one of a comparison of a first center frequency associated with the candidate measurement object and a second center frequency associated with the measured measurement object when the candidate measurement object is located within the configured BW and outside the active BWP, as described in connection with the first scenario 810 of FIG. 8.

In some examples, the capability of the UE (e.g., at 1002) may be indicated for at least one of per frequency, per cell, or per band when the candidate measurement object is located outside the configured BW and outside the active BWP. In some such examples, the capability of the UE may be further based on at least one of carrier aggregation and a candidate cell configuration when the candidate measurement object is located outside the configured BW and outside the active BWP, as described in connection with the second scenario 820 of FIG. 8.

In some examples, the capability of the UE (e.g., at 1002) may be based on at least one of a comparison of a first subcarrier spacing associated with the candidate measurement object and a second subcarrier spacing associated with the measured measurement object when the candidate measurement object is located outside the configured BW and outside the active BWP, as described in connection with the second scenario 820 of FIG. 8.

In some examples, the capability of the UE (e.g., at 1002) may be based on at least one of a comparison of a first center frequency associated with the candidate measurement object and a second center frequency associated with the measured measurement object when the candidate measurement object is located outside the configured BW and outside the active BWP, as described in connection with the second scenario 820 of FIG. 8.

In some examples, the capability of the UE (e.g., at 1002) may be indicated for at least one of per frequency, per cell, or per band when the candidate measurement object is located within the configured BW and the active BWP and with at least one of the center frequency or the subcarrier spacing being different than the measured measurement object of the activated serving cell, as described in connection with the third scenario 830 of FIG. 8.

In some examples, the capability of the UE (e.g., at 1002) may be further based on at least one of carrier aggregation and a candidate cell configuration when the candidate measurement object is located within the configured BW and the active BWP and with at least one of the center frequency or the subcarrier spacing being different than the measured measurement object of the activated serving cell, as described in connection with the third scenario 830 of FIG. 8.

In some examples, the capability of the UE (e.g., at 1002) may be further based on whether the measured measurement object is located within the active BWP, as described in connection with the third scenario 830 of FIG. 8.

In some examples in which the L1 measurement configuration (e.g., at 1004) is rule-based, and where, based on a relationship between the candidate measurement object, the configured BW, and the active BWP, the L1 measurement configuration may configure the UE to at least one of: perform the L1 measurement for the candidate measurement object within measurement gaps, perform the L1 measurement for the candidate measurement object without measurement gaps, or discard performing the L1 measurement for the candidate measurement object, as described in connection with the first rule 912a, the second rule 912b, and/or the third rule 912c of FIG. 9.

In some examples, the L1 measurement (e.g., at 1006) may include an L1 intra-frequency measurement or an L1 inter-frequency measurement.

In some examples, the L1 measurement (e.g., at 1006) may include the L1 inter-frequency measurement when at least one of: the candidate measurement object is located within the configured BW of the activated serving cell and outside the active BWP, the candidate measurement object is located outside the configured BW and outside the active BWP, the candidate measurement object is located within the configured BW and the active BWP and with at least one of the center frequency or the subcarrier spacing being different than the measured measurement object of the activated serving cell, or the candidate measurement object has at least one of the center frequency or the subcarrier spacing that is different than measurement objects of any activated serving cells.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers (e.g., a cellular RF transceiver 1122). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize one or more antennas 1180 for communication. The cellular baseband processor 1124 communicates through transceiver(s) (e.g., the cellular RF transceiver 1122) via one or more antennas 1180 with the UE 104 and/or with an RU associated with a network entity 1102. The cellular baseband processor 1124 and the application processor 1106 may each include a computer-readable medium/memory, such as the on-chip memory 1124′, and the on-chip memory 1106′, respectively. The additional memory modules 1126 may also be considered a computer-readable medium/memory. Each computer-readable medium/memory (e.g., the on-chip memory 1124′, the on-chip memory 1106′, and/or the additional memory modules 1126) may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see the UE 350 of FIG. 3) and include the additional modules of the apparatus 1104.

As discussed supra, the measurement component 198 is configured to receive an L1 measurement configuration for a set of SpCells for L1 or L2 inter-cell mobility. The L1 measurement configuration may be associated with a measurement gap for a measurement object that is located at least at one of: within a configured BW of an activated serving cell and outside an active BWP, outside the configured BW and outside the active BWP, or within the configured BW and the active BWP and with at least one of a center frequency or a subcarrier spacing that is different than a measured measurement object of the activated serving cell. The example measurement component 198 may also be configured to perform an L1 measurement for a candidate measurement object based on the L1 measurement configuration. Additionally, the example measurement component 198 may be configured to transmit an L1 measurement report based on the L1 measurement.

The measurement component 198 may be within the cellular baseband processor 1124, the application processor 1106, or both the cellular baseband processor 1124 and the application processor 1106. The measurement component 198 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1104 may include a variety of components configured for various functions. For example, the measurement component 198 may include one or more hardware components that perform each of the blocks of the algorithm in the flowchart of FIG. 10.

In one configuration, the apparatus 1104, and in particular the cellular baseband processor 1124 and/or the application processor 1106, includes means for receiving an L1 measurement configuration for a set of SpCells for L1 or L2 inter-cell mobility, the L1 measurement configuration associated with a measurement gap for a measurement object that is located at least at one of: within a configured BW of an activated serving cell and outside an active BWP, outside the configured BW and outside the active BWP, or within the configured BW and the active BWP and with at least one of a center frequency or a subcarrier spacing that is different than a measured measurement object of the activated serving cell. The example apparatus 1104 also includes means for performing an L1 measurement for a candidate measurement object based on the L1 measurement configuration. The example apparatus 1104 also includes means for transmitting an L1 measurement report based on the L1 measurement.

In another configuration, the example apparatus 1104 also includes means for transmitting a capability of the UE to perform the L1 measurement without measurement gaps, and where the L1 measurement configuration indicates whether the UE is to perform the L1 measurement with or without the measurement gaps based on the capability.

In another configuration, the example apparatus 1104 also includes means for performing the L1 measurement for the candidate measurement object within measurement gaps. The example apparatus 1104 also includes means for performing the L1 measurement for the candidate measurement object without measurement gaps. The example apparatus 1104 also includes means for discarding performing the L1 measurement for the candidate measurement object.

The means may be the measurement component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

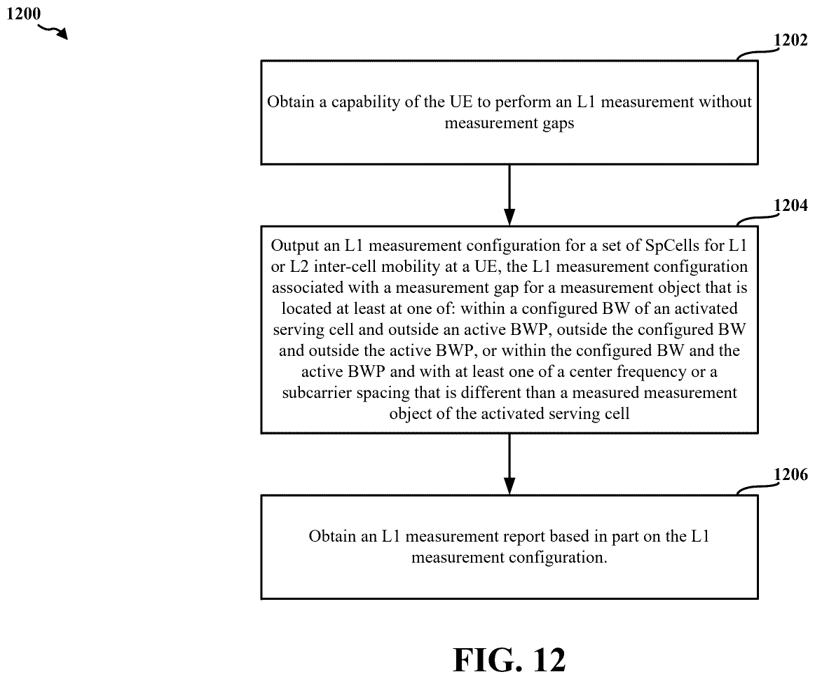

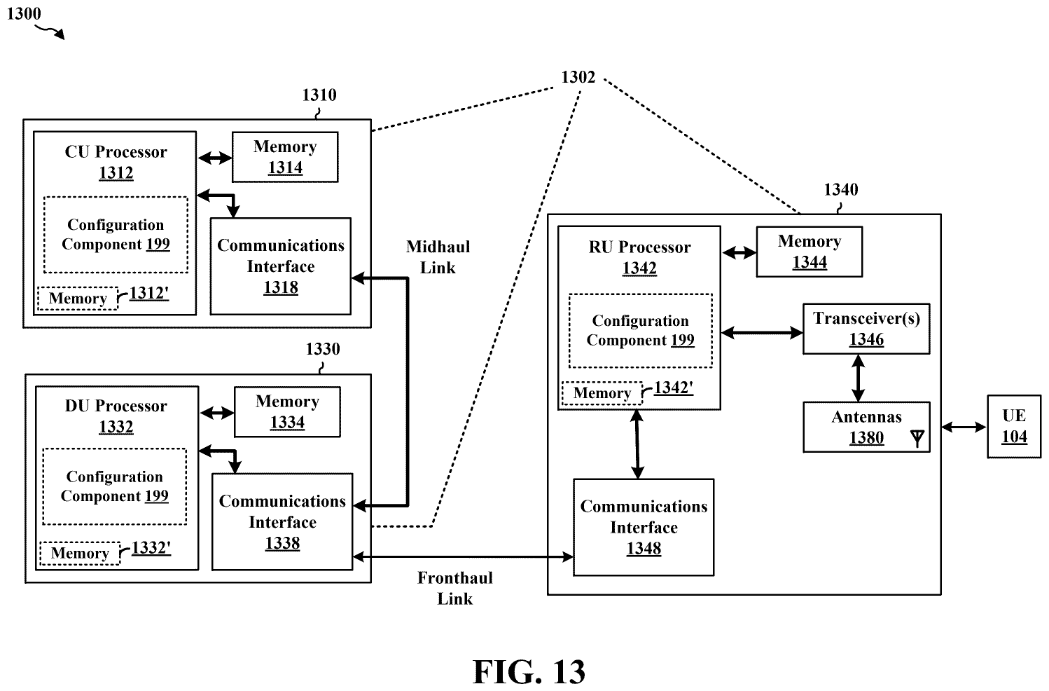

FIG. 12 is a flowchart 1200 of a method of wireless communication. The method may be performed by a network entity (e.g., the base station 102, and/or a network entity 1302 of FIG. 13). The method may facilitate performing L1 measurements with measurement gaps requirements in L1/L2 inter-cell mobility scenarios. Thus, the method may facilitate improving the efficiency of wireless communications.

At 1204, the network entity outputs an L1 measurement configuration for a set of SpCells for L1 or L2 inter-cell mobility at a UE, the L1 measurement configuration associated with a measurement gap for a measurement object that is located at least at one of: within a configured BW of an activated serving cell and outside an active BWP, outside the configured BW and outside the active BWP, or within the configured BW and the active BWP and with at least one of a center frequency or a subcarrier spacing that is different than a measured measurement object of the activated serving cell, as described in connection with the measurement configuration 912 of FIG. 9. The outputting of the L1 measurement configuration, at 1204, may be performed by the configuration component 199 of the network entity 1302 of FIG. 13.

At 1206, the network entity obtains an L1 measurement report based in part on the L1 measurement configuration, as described in connection with the measurement report 918 of FIG. 9. For example, the obtaining of the L1 measurement report, at 1206, may be performed by the configuration component 199 of the network entity 1302 of FIG. 13.

In some examples, the L1 measurement configuration (e.g., at 1204) may be at least one of capability-based or rule-based.

In some examples in which the L1 measurement configuration (e.g., at 1204) is capability-based, the network entity may obtain, at 1202, a capability of the UE to perform an L1 measurement without measurement gaps, as described in connection with the capability 910 of FIG. 9. In some such examples, the L1 measurement configuration (e.g., at 1204) may indicate whether the UE is to perform the L1 measurement with or without the measurement gaps based on the capability. The obtaining of the capability, at 1202, may be performed by the configuration component 199 of the network entity 1302 of FIG. 13.

In some examples, the L1 measurement configuration (e.g., at 1204) may indicate that the UE is to perform the L1 measurement with or without the measurement gaps based on at least one of a comparison of a first subcarrier spacing associated with a candidate measurement object and a second subcarrier spacing associated with the measured measurement object when the candidate measurement object is located within the configured BW and outside the active BWP, as described in connection with the first scenario 810 of FIG. 8.

In some examples, the L1 measurement configuration (e.g., at 1204) may indicate that the UE is to perform the L1 measurement with or without the measurement gaps based on at least one of a comparison of a first center frequency associated with a candidate measurement object and a second center frequency associated with the measured measurement object when the candidate measurement object is located within the configured BW and outside the active BWP, as described in connection with the first scenario 810 of FIG. 8.

In some examples, the capability of the UE (e.g., at 1202) may be indicated for at least one of per frequency, per cell, or per band when a candidate measurement object is located outside the configured BW and outside the active BWP, as described in connection with the second scenario 820 of FIG. 8.

In some examples, the L1 measurement configuration (e.g., at 1204) may indicate that the UE is to perform the L1 measurement with or without the measurement gaps based on at least one of a comparison of a first subcarrier spacing associated with a candidate measurement object and a second subcarrier spacing associated with the measured measurement object when the candidate measurement object is located outside the configured BW and outside the active BWP, as described in connection with the second scenario 820 of FIG. 8.

In some examples, the L1 measurement configuration (e.g., at 1204) may indicate that the UE is to perform the L1 measurement with or without the measurement gaps based on at least one of a comparison of a first center frequency associated with a candidate measurement object and a second center frequency associated with the measured measurement object when the candidate measurement object is located outside the configured BW and outside the active BWP, as described in connection with the second scenario 820 of FIG. 8.

In some examples, the capability of the UE (e.g., at 1202) may be indicated for at least one of per frequency, per cell, or per band when a candidate measurement object is located within the configured BW and the active BWP and with at least one of the center frequency or the subcarrier spacing being different than the measured measurement object of the activated serving cell as described in connection with the third scenario 830 of FIG. 8.

In some examples, the L1 measurement configuration (e.g., at 1204) may indicate that the UE is to perform the L1 measurement with or without the measurement gaps based on whether the measured measurement object is located within the active BWP, as described in connection with the third scenario 830 of FIG. 8.

In some examples, the L1 measurement configuration (e.g., at 1204) may be rule-based, and where, based on a relationship between a candidate measurement object, the configured BW, and the active BWP, the L1 measurement configuration configures the UE to at least one of: perform an L1 measurement for the candidate measurement object within measurement gaps, perform the L1 measurement for the candidate measurement object without measurement gaps, or discard performing the L1 measurement for the candidate measurement object as described in connection with the first rule 912a, the second rule 912b, and/or the third rule 912c of FIG. 9.

In some examples, an L1 measurement of the L1 measurement report (e.g., at 1206) may include an L1 intra-frequency measurement or an L1 inter-frequency measurement.

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the configuration component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memories (e.g., the on-chip memory 1312′, the on-chip memory 1332′, and/or the on-chip memory 1342′) and/or the additional memory modules (e.g., the additional memory modules 1314, the additional memory modules 1334, and/or the additional memory modules 1344) may each be considered a computer-readable medium/memory. Each computer-readable medium/memory may be non-transitory. Each of the CU processor 1312, the DU processor 1332, the RU processor 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the configuration component 199 is configured to output an L1 measurement configuration for a set of SpCells for L1 or L2 inter-cell mobility at a UE. The L1 measurement configuration may be associated with a measurement gap for a measurement object that is located at least at one of: within a configured BW of an activated serving cell and outside an active BWP, outside the configured BW and outside the active BWP, or within the configured BW and the active BWP and with at least one of a center frequency or a subcarrier spacing that is different than a measured measurement object of the activated serving cell. The example configuration component 199 may also be configured to obtain an L1 measurement report based in part on the L1 measurement configuration.

The configuration component 199 may be within one or more processors of one or more of the CU 1310, DU 1330, and the RU 1340. The configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof.

The network entity 1302 may include a variety of components configured for various functions. For example, the configuration component 199 may include one or more hardware components that perform each of the blocks of the algorithm in the flowchart of FIG. 12.

In one configuration, the network entity 1302 includes means for outputting an L1 measurement configuration for a set of SpCells for L1 or L2 inter-cell mobility at a UE, the L1 measurement configuration associated with a measurement gap for a measurement object that is located at least at one of: within a configured BW of an activated serving cell and outside an active BWP, outside the configured BW and outside the active BWP, or within the configured BW and the active BWP and with at least one of a center frequency or a subcarrier spacing that is different than a measured measurement object of the activated serving cell. The example network entity 1302 also includes means for obtaining an L1 measurement report based in part on the L1 measurement configuration.

In another configuration, the example network entity 1302 also includes means for obtaining a capability of the UE to perform an L1 measurement without measurement gaps, and where the L1 measurement configuration indicates whether the UE is to perform the L1 measurement with or without the measurement gaps based on the capability.

In another configuration, the example network entity 1302 also includes means for performing an L1 measurement for the candidate measurement object within measurement gaps. The example network entity 1302 also includes means for performing the L1 measurement for the candidate measurement object without measurement gaps. The example network entity 1302 also includes means for discarding performing the L1 measurement for the candidate measurement object.

The means may be the configuration component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

As noted above, a network may aim to ensure that a UE maintains connectivity with a network entity (e.g., a base station) as the UE moves within a network. Mobility management may enable tracking a UE in order to provide services to the UE. Mobility management may include signaling among different network entities and the UE. In some examples, to help reduce mobility latency, a network and a UE may employ L1/L2 inter-cell mobility. L1/L2 signaling may facilitate inter-cell mobility based on UE-dedicated channels and/or RSs.

In some examples, a network may change the SpCell for a UE, for example, from a first SpCell to a second SpCell. The network may change the SpCell for a UE based on measurements performed by the UE. In some examples, the measurements may include L3 intra-frequency measurements, L3 inter-frequency measurements, and/or L1-RSRP measurements.

However, L1/L2 inter-cell mobility may support both intra-frequency scenarios and inter-frequency scenarios. In some examples, inter-frequency scenarios may be based on a relationship between a candidate measurement object, a configured BW, and an active BWP.

Aspects disclosed herein provide techniques for configuring measurement gaps (or configuring no measurement gaps) for different inter-frequency scenarios. For example, a UE may receive an L1 measurement configuration for a set of SpCells for L1 or L2 inter-cell mobility. The L1 measurement configuration may be associated with a measurement gap for a measurement object that is located at least at one of: within a configured BW of an activated serving cell and outside an active BWP, outside the configured BW and outside the active BWP, or within the configured BW and the active BWP and with at least one of a center frequency or a subcarrier spacing that is different than a measured measurement object of the activated serving cell. The UE may also perform an L1 measurement for a candidate measurement object based on the L1 measurement configuration. Additionally, the UE may transmit an L1 measurement report based on the L1 measurement. Such techniques may improve the efficiency of wireless communications.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: receiving a layer 1 (L1) measurement configuration for a set of special cells (SpCells) for L1 or layer 2 (L2) inter-cell mobility, the L1 measurement configuration associated with a measurement gap for a measurement object that is located at least at one of: within a configured bandwidth (BW) of an activated serving cell and outside an active bandwidth part (BWP), outside the configured BW and outside the active BWP, or within the configured BW and the active BWP and with at least one of a center frequency or a subcarrier spacing that is different than a measured measurement object of the activated serving cell; performing an L1 measurement for a candidate measurement object based on the L1 measurement configuration; and transmitting an L1 measurement report based on the L1 measurement.

Aspect 2 is the method of aspect 1, further including that the L1 measurement configuration is at least one of capability-based or rule-based.

Aspect 3 is the method of any of aspects 1 and 2, further including that the L1 measurement configuration is capability-based, the method further comprising: transmitting a capability of the UE to perform the L1 measurement without measurement gaps, and where the L1 measurement configuration indicates whether the UE is to perform the L1 measurement with or without the measurement gaps based on the capability.

Aspect 4 is the method of any of aspects 1 to 3, further including that the capability of the UE is based on at least one of a comparison of a first subcarrier spacing associated with the candidate measurement object and a second subcarrier spacing associated with the measured measurement object when the candidate measurement object is located within the configured BW and outside the active BWP.

Aspect 5 is the method of any of aspects 1 to 4, further including that the capability of the UE is based on at least one of a comparison of a first center frequency associated with the candidate measurement object and a second center frequency associated with the measured measurement object when the candidate measurement object is located within the configured BW and outside the active BWP.

Aspect 6 is the method of any of aspects 1 to 3, further including that the capability of the UE is indicated for at least one of per frequency, per cell, or per band when the candidate measurement object is located outside the configured BW and outside the active BWP.

Aspect 7 is the method of any of aspects 1 to 3 and 6, further including that the capability of the UE is further based on at least one of carrier aggregation and a candidate cell configuration when the candidate measurement object is located outside the configured BW and outside the active BWP.

Aspect 8 is the method of any of aspects 1 to 3 and 6, further including that the capability of the UE is based on at least one of a comparison of a first subcarrier spacing associated with the candidate measurement object and a second subcarrier spacing associated with the measured measurement object when the candidate measurement object is located outside the configured BW and outside the active BWP.

Aspect 9 is the method of any of aspects 1 to 3 and 6, further including that the capability of the UE is based on at least one of a comparison of a first center frequency associated with the candidate measurement object and a second center frequency associated with the measured measurement object when the candidate measurement object is located outside the configured BW and outside the active BWP.

Aspect 10 is the method of any of aspects 1 to 3, further including that the capability of the UE is indicated for at least one of per frequency, per cell, or per band when the candidate measurement object is located within the configured BW and the active BWP and with at least one of the center frequency or the subcarrier spacing being different than the measured measurement object of the activated serving cell.

Aspect 11 is the method of any of aspects 1 to 3 and 10, further including that the capability of the UE is further based on at least one of carrier aggregation and a candidate cell configuration when the candidate measurement object is located within the configured BW and the active BWP and with at least one of the center frequency or the subcarrier spacing being different than the measured measurement object of the activated serving cell.

Aspect 12 is the method of any of aspects 1 to 3 and 10, further including that the capability of the UE is further based on whether the measured measurement object is located within the active BWP.

Aspect 13 is the method of any of aspects 1 and 2, further including that the L1 measurement configuration is rule-based, and where, based on a relationship between the candidate measurement object, the configured BW, and the active BWP, the L1 measurement configuration configures the UE to at least one of: perform the L1 measurement for the candidate measurement object within measurement gaps, perform the L1 measurement for the candidate measurement object without measurement gaps, or discard performing the L1 measurement for the candidate measurement object.

Aspect 14 is the method of any of aspects 1 to 13, further including that the L1 measurement includes an L1 intra-frequency measurement or an L1 inter-frequency measurement.

Aspect 15 is the method of any of aspects 1 to 14, further including that the L1 measurement includes the L1 inter-frequency measurement when at least one of: the candidate measurement object is located within the configured BW of the activated serving cell and outside the active BWP, the candidate measurement object is located outside the configured BW and outside the active BWP, the candidate measurement object is located within the configured BW and the active BWP and with at least one of the center frequency or the subcarrier spacing being different than the measured measurement object of the activated serving cell, or the candidate measurement object has at least one of the center frequency or the subcarrier spacing that is different than measurement objects of any activated serving cells.

Aspect 16 is an apparatus for wireless communication at a UE including at least one processor coupled to a memory and configured to implement any of aspects 1 to 15.

In aspect 17, the apparatus of aspect 16 further includes at least one antenna coupled to the at least one processor.

In aspect 18, the apparatus of aspect 16 or 17 further includes a transceiver coupled to the at least one processor.

Aspect 19 is an apparatus for wireless communication including means for implementing any of aspects 1 to 15.

In aspect 20, the apparatus of aspect 19 further includes at least one antenna coupled to the means to perform the method of any of aspects 1 to 15.

In aspect 21, the apparatus of aspect 19 or 20 further includes a transceiver coupled to the means to perform the method of any of aspects 1 to 15.

Aspect 22 is a non-transitory computer-readable storage medium storing computer executable code, where the code, when executed, causes a processor to implement any of aspects 1 to 15.

Aspect 23 is a method of wireless communication at a network entity, including: outputting a layer 1 (L1) measurement configuration for a set of special cells (SpCells) for L1 or layer 2 (L2) inter-cell mobility at a user equipment (UE), the L1 measurement configuration associated with a measurement gap for a measurement object that is located at least at one of: within a configured bandwidth (BW) of an activated serving cell and outside an active bandwidth part (BWP), outside the configured BW and outside the active BWP, or within the configured BW and the active BWP and with at least one of a center frequency or a subcarrier spacing that is different than a measured measurement object of the activated serving cell; and obtaining an L1 measurement report based in part on the L1 measurement configuration.

Aspect 24 is the method of aspect 23, further including that the L1 measurement configuration is at least one of capability-based or rule-based.

Aspect 25 is the method of any of aspects 23 and 24, further including that the L1 measurement configuration is capability-based, the method further comprising: obtaining a capability of the UE to perform an L1 measurement without measurement gaps, and where the L1 measurement configuration indicates whether the UE is to perform the L1 measurement with or without the measurement gaps based on the capability.

Aspect 26 is the method of any of aspects 23 to 25, further including that the L1 measurement configuration indicates that the UE is to perform the L1 measurement with or without the measurement gaps based on at least one of a comparison of a first subcarrier spacing associated with a candidate measurement object and a second subcarrier spacing associated with the measured measurement object when the candidate measurement object is located within the configured BW and outside the active BWP.

Aspect 27 is the method of any of aspects 23 to 26, further including that the L1 measurement configuration indicates that the UE is to perform the L1 measurement with or without the measurement gaps based on at least one of a comparison of a first center frequency associated with a candidate measurement object and a second center frequency associated with the measured measurement object when the candidate measurement object is located within the configured BW and outside the active BWP.

Aspect 28 is the method of any of aspects 23 to 25, further including that the capability of the UE is indicated for at least one of per frequency, per cell, or per band when a candidate measurement object is located outside the configured BW and outside the active BWP.

Aspect 29 is the method of any of aspects 23 to 25 and 28, further including that the L1 measurement configuration indicates that the UE is to perform the L1 measurement with or without the measurement gaps based on at least one of a comparison of a first subcarrier spacing associated with a candidate measurement object and a second subcarrier spacing associated with the measured measurement object when the candidate measurement object is located outside the configured BW and outside the active BWP.

Aspect 30 is the method of any of aspects 23 to 25 and 28, further including that the L1 measurement configuration indicates that the UE is to perform the L1 measurement with or without the measurement gaps based on at least one of a comparison of a first center frequency associated with a candidate measurement object and a second center frequency associated with the measured measurement object when the candidate measurement object is located outside the configured BW and outside the active BWP.

Aspect 31 is the method of any of aspects 23 to 25, further including that the capability of the UE is indicated for at least one of per frequency, per cell, or per band when a candidate measurement object is located within the configured BW and the active BWP and with at least one of the center frequency or the subcarrier spacing being different than the measured measurement object of the activated serving cell.

Aspect 32 is the method of any of aspects 23 to 25 and 31, further including that the L1 measurement configuration indicates that the UE is to perform the L1 measurement with or without the measurement gaps based on whether the measured measurement object is located within the active BWP.

Aspect 33 is the method of any of aspects 23 and 24, further including that the L1 measurement configuration is rule-based, and where, based on a relationship between a candidate measurement object, the configured BW, and the active BWP, the L1 measurement configuration configures the UE to at least one of: perform an L1 measurement for the candidate measurement object within measurement gaps, perform the L1 measurement for the candidate measurement object without measurement gaps, or discard performing the L1 measurement for the candidate measurement object.

Aspect 34 is the method of any of aspects 23 to 33, further including that an L1 measurement of the L1 measurement report includes an L1 intra-frequency measurement or an L1 inter-frequency measurement.

Aspect 35 is an apparatus for wireless communication at a network entity including at least one processor coupled to a memory and configured to implement any of aspects 23 to 34.

In aspect 36, the apparatus of aspect 35 further includes at least one antenna coupled to the at least one processor.

In aspect 37, the apparatus of aspect 35 or 36 further includes a transceiver coupled to the at least one processor.

Aspect 38 is an apparatus for wireless communication including means for implementing any of aspects 23 to 34.

In aspect 39, the apparatus of aspect 38 further includes at least one antenna coupled to the means to perform the method of any of aspects 23 to 34.

In aspect 40, the apparatus of aspect 38 or 39 further includes a transceiver coupled to the means to perform the method of any of aspects 23 to 34.

Aspect 41 is a non-transitory computer-readable storage medium storing computer executable code, where the code, when executed, causes a processor to implement any of aspects 23 to 34.

1. An apparatus for wireless communication at a user equipment (UE), comprising:
a memory; and
at least one processor coupled to the memory and, based at least in part on information stored in the memory, the at least one processor is configured to:
receive a layer 1 (L1) measurement configuration for a set of special cells (SpCells) for L1 or layer 2 (L2) inter-cell mobility, the L1 measurement configuration associated with a measurement gap for a measurement object that is located at least at one of:
within a configured bandwidth (BW) of an activated serving cell and outside an active bandwidth part (BWP),
outside the configured BW and outside the active BWP, or
within the configured BW and the active BWP and with at least one of a center frequency or a subcarrier spacing that is different than a measured measurement object of the activated serving cell;
perform an L1 measurement for a candidate measurement object based on the L1 measurement configuration; and
transmit an L1 measurement report based on the L1 measurement.

2. The apparatus of claim 1, wherein the L1 measurement configuration is at least one of capability-based or rule-based.

3. The apparatus of claim 2, wherein the L1 measurement configuration is capability-based, the apparatus further including:
at least one transceiver coupled to the at least one processor and configured to transmit a capability of the UE to perform the L1 measurement without measurement gaps, and wherein the L1 measurement configuration indicates whether the UE is to perform the L1 measurement with or without the measurement gaps based on the capability.

4. The apparatus of claim 3, wherein the capability of the UE is based on at least one of a comparison of a first subcarrier spacing associated with the candidate measurement object and a second subcarrier spacing associated with the measured measurement object when the candidate measurement object is located within the configured BW and outside the active BWP.

5. The apparatus of claim 3, wherein the capability of the UE is based on at least one of a comparison of a first center frequency associated with the candidate measurement object and a second center frequency associated with the measured measurement object when the candidate measurement object is located within the configured BW and outside the active BWP.

6. The apparatus of claim 3, wherein the capability of the UE is indicated for at least one of per frequency, per cell, or per band when the candidate measurement object is located outside the configured BW and outside the active BWP.

7. The apparatus of claim 6, wherein the capability of the UE is further based on at least one of carrier aggregation and a candidate cell configuration when the candidate measurement object is located outside the configured BW and outside the active BWP.

8. The apparatus of claim 3, wherein the capability of the UE is based on at least one of a comparison of a first subcarrier spacing associated with the candidate measurement object and a second subcarrier spacing associated with the measured measurement object when the candidate measurement object is located outside the configured BW and outside the active BWP.

9. The apparatus of claim 3, wherein the capability of the UE is based on at least one of a comparison of a first center frequency associated with the candidate measurement object and a second center frequency associated with the measured measurement object when the candidate measurement object is located outside the configured BW and outside the active BWP.

10. The apparatus of claim 3, wherein the capability of the UE is indicated for at least one of per frequency, per cell, or per band when the candidate measurement object is located within the configured BW and the active BWP and with at least one of the center frequency or the subcarrier spacing being different than the measured measurement object of the activated serving cell.

11. The apparatus of claim 10, wherein the capability of the UE is further based on at least one of carrier aggregation and a candidate cell configuration when the candidate measurement object is located within the configured BW and the active BWP and with at least one of the center frequency or the subcarrier spacing being different than the measured measurement object of the activated serving cell.

12. The apparatus of claim 10, wherein the capability of the UE is further based on whether the measured measurement object is located within the active BWP.

13. The apparatus of claim 2, wherein the L1 measurement configuration is rule-based, and wherein, based on a relationship between the candidate measurement object, the configured BW, and the active BWP, the L1 measurement configuration configures the UE to at least one of:
perform the L1 measurement for the candidate measurement object within measurement gaps,
perform the L1 measurement for the candidate measurement object without measurement gaps, or
discard performing the L1 measurement for the candidate measurement object.

14. The apparatus of claim 1, wherein the L1 measurement includes an L1 intra-frequency measurement or an L1 inter-frequency measurement.

15. The apparatus of claim 14, wherein the L1 measurement includes the L1 inter-frequency measurement when at least one of:
the candidate measurement object is located within the configured BW of the activated serving cell and outside the active BWP,
the candidate measurement object is located outside the configured BW and outside the active BWP,
the candidate measurement object is located within the configured BW and the active BWP and with at least one of the center frequency or the subcarrier spacing being different than the measured measurement object of the activated serving cell, or
the candidate measurement object has at least one of the center frequency or the subcarrier spacing that is different than measurement objects of any activated serving cells.

16. A method of wireless communication at a user equipment (UE), comprising:
receiving a layer 1 (L1) measurement configuration for a set of special cells (SpCells) for L1 or layer 2 (L2) inter-cell mobility, the L1 measurement configuration associated with a measurement gap for a measurement object that is located at least at one of:
within a configured bandwidth (BW) of an activated serving cell and outside an active bandwidth part (BWP),
outside the configured BW and outside the active BWP, or
within the configured BW and the active BWP and with at least one of a center frequency or a subcarrier spacing that is different than a measured measurement object of the activated serving cell;
performing an L1 measurement for a candidate measurement object based on the L1 measurement configuration; and
transmitting an L1 measurement report based on the L1 measurement.

17. An apparatus for wireless communication at a network entity, comprising:
a memory; and
at least one processor coupled to the memory and, based at least in part on information stored in the memory, the at least one processor is configured to:
output a layer 1 (L1) measurement configuration for a set of special cells (SpCells) for L1 or layer 2 (L2) inter-cell mobility at a user equipment (UE), the L1 measurement configuration associated with a measurement gap for a measurement object that is located at least at one of:
within a configured bandwidth (BW) of an activated serving cell and outside an active bandwidth part (BWP),
outside the configured BW and outside the active BWP, or
within the configured BW and the active BWP and with at least one of a center frequency or a subcarrier spacing that is different than a measured measurement object of the activated serving cell; and
obtaining an L1 measurement report based in part on the L1 measurement configuration.

18. The apparatus of claim 17, wherein the L1 measurement configuration is at least one of capability-based or rule-based.

19. The apparatus of claim 18, wherein the L1 measurement configuration is capability-based, the apparatus further including:
at least one transceiver coupled to the at least one processor and configured to obtain a capability of the UE to perform an L1 measurement without measurement gaps, and wherein the L1 measurement configuration indicates whether the UE is to perform the L1 measurement with or without the measurement gaps based on the capability.

20. The apparatus of claim 19, wherein the L1 measurement configuration indicates that the UE is to perform the L1 measurement with or without the measurement gaps based on at least one of a comparison of a first subcarrier spacing associated with a candidate measurement object and a second subcarrier spacing associated with the measured measurement object when the candidate measurement object is located within the configured BW and outside the active BWP.

21.-29. (canceled)
